(19) United States
(12) Patent Application Publication
(10) Pub. No.: US 2025/0291134 A1
(43) Pub. Date: Sep. 18, 2025

(54) OPTICAL CONNECTORS WITH ALIGNMENT FEATURES

(71) Applicant: Intel Corporation, Santa Clara, CA (US)

(72) Inventors: Wesley Morgan, Lake Oswego, OR (US); Paul Diglio, Gaston, OR (US); Srikant Nekkanty, Chandler, AZ (US); Mohanraj Prabhugoud, Hillsboro, OR (US); David Shia, Portland, OR (US); Nicholas Psaila, Lanark (GB)

(73) Assignee: Intel Corporation, Santa Clara, CA (US)

(21) Appl. No.: 18/608,006

(22) Filed: Mar. 18, 2024

(51) Int. Cl. G02B 6/42; G02B 6/36; G02B 6/38

(52) U.S. Cl. CPC G02B 6/4231; G02B 6/3881; G02B 6/3636

(57) ABSTRACT

An optical connector includes a body with a first connector interface and a second connector interface opposite the first connector interface. The body includes a first alignment structure and a second alignment structure, and the first and second alignment structure extend between the first connector interface and the second connector interface. The first alignment structure and the second alignment structure differ in a dimension.

### BACKGROUND

Photonic integrated circuits (PICs) can be used for several applications, including communications. In order for a PIC to send or receive optical signals to or from an external component or device, optical fibers (or, simply, fibers) of a fiber array unit (FAU) external to the PIC may be connected with the PIC through an optical connector such as a ferrule. Optical signals provided by the fibers inserted into the optical connector can be fed through an optical bridge or waveguide structure to the PIC.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, not by way of limitation, in the figures of the accompanying drawings.

FIG. 1 is a perspective view of an example optical assembly, in accordance with some embodiments.

FIG. 2 is an exploded perspective view of a portion of the example optical assembly of FIG. 1.

FIG. 3A is a perspective view of an example optical bridge structure, in accordance with some embodiments.

FIG. 3B is front view of the example optical bridge structure of FIG. 3A.

FIG. 4A is a perspective view of an example optical connector, in accordance with some embodiments.

FIG. 4B is a front view of the example optical connector of FIG. 4A.

FIG. 5 is a perspective view of an example optical connector holder, in accordance with some embodiments.

FIG. 6 is a perspective view of the example optical connector holder of FIG. 5 together with alignment elements, in accordance with some embodiments.

FIG. 7A is a perspective view of an example optical connector housing, in accordance with some embodiments.

FIG. 7B is a plan view of the example optical connector housing of FIG. 7A.

FIG. 8 is a perspective view of an example optical assembly, in accordance with some embodiments.

FIGS. 9A-9C are perspective views of an example optical assembly, in accordance with some embodiments.

FIG. 9D is a front view of the example optical assembly of FIG. 9C, the front view omitting an optical connector housing.

FIG. 10 is a perspective view of an alternative example optical bridge structure, in accordance with some embodiments.

FIG. 11 is a perspective view of an alternative example optical connector, in accordance with some embodiments.

FIG. 12 is a perspective view of an alternative example optical connector holder, in accordance with some embodiments.

FIG. 13A is a perspective view of an example optical assembly, in accordance with some embodiments.

FIG. 13B is a cross-sectional view of the example optical assembly of FIG. 13A along plane c-c.

FIGS. 14A-14D are plan views of an example optical assembly, in accordance with some embodiments.

FIG. 15A and FIG. 15B are perspective views of a first component of an alternative example optical holder assembly, in accordance with some embodiments.

FIG. 16 is a perspective view of a second component of an alternative example optical holder assembly, in accordance with some embodiments.

FIG. 17A and FIG. 17B are perspective views of an example optical assembly, in accordance with some embodiments.

FIG. 18 is a top view of a wafer and dies that may be included in a microelectronic package or a photonic device that may include an optical assembly or sub-assembly, in accordance with some embodiments.

FIG. 19 is a side, cross-sectional view of an example microelectronic package, in accordance with some embodiments.

FIG. 20 is a block diagram of a photonic device that may include an optical assembly or sub-assembly, in accordance with some embodiments.

### DETAILED DESCRIPTION

As noted above, fibers of an FAU may be inserted into an optical connector, and optical signals from the fibers in the optical connector may be fed through an optical bridge structure optically coupled to the PIC. To establish an optical path along which communication of optical signals between the optical connector and the optical bridge structure can be facilitated, the optical connector and optical bridge structure may be physically aligned relative to one another by the way of alignment features or alignment structures. As an example, one or more alignment structures of the optical connector may interface or engage with one or more alignment structures of the optical bridge structure in order to reliably form an optical path between openings of the optical connector and openings of the optical bridge structure (e.g., with minimal or no obstructions in the optical path due to misalignment).

In the example above, the selection and optimization of particular alignment structures of the optical connector and optical bridge structure may be challenging. Alignment structures that are large or bulky, or have a high footprint, may not be suitable for some applications for which small size optical connector or optical bridge structures are desired (for example, for use with a photonic or co-packaged assembly having small size components, or small spaces between components).

Some alignment structures, such as complementary interfacing pin and hole structures, can be challenging to use with an optical connector or an optical bridge structure. For example, for an optical connector with an integrated pin structure (e.g., a glass optical connector with a glass pin structure) and an optical bridge structure (e.g., a glass optical bridge structure) with a hole feature, contact between the pin and the hole may cause wear or damage to the pin, the hole, or other parts of the optical connector or optical bridge structure. The risk of wear or damage may increase if multiple cycles of insertion and withdrawal of the pin occur. Erosion of, or damage to, the alignment structures (e.g., the pin or hole), the optical connector, or optical bridge structure can increase the risk that an optical path between the optical connector and the optical bridge structure cannot be reliably formed. High-volume manufacturing may also be challenging to achieve for alignment structures on optical connector or optical bridge structures. For example, alignment structures on the optical connector or optical bridge structure (e.g., made from an optically transparent material, such as a transparent glass material) may be challenging to inspect or measure for quality control in a rapid manner.

Additionally, in some cases where alignment structures of an optical connector and an optical bridge structure interface or engage, it may be challenging to select and optimize the alignment structures such that a robust engagement or alignment can be achieved with low risk of misalignment due to displacement or forces between the optical connector and optical bridge structure (e.g., due to vibrations or shaking, collisions with other components, impacts, or other disturbances). In some cases, it is desirable to constrain or limit relative movement between the optical connector and optical bridge structure along multiple degrees of freedom (e.g. relative rotational movement along multiple axes, such as pitch, roll, or yaw axes, or translational movement along multiple axes, such as x-, y-, or z-axes) in order to minimize risk of misalignment.

Disclosed herein are optical bridge structures, optical connectors, and optical connector holders that aim to address one or more challenges described above. Additionally, disclosed herein are optical assemblies (e.g. photonic assemblies) and optical systems (e.g., photonic systems), the optical assemblies or optical systems including one or more optical bridge structures, optical connectors, and/or optical connector holders that aim to address one or more challenges described above. An example optical connector includes a body with a first connector interface, a second connector interface opposite to the first connector interface, and a surface between the first and second connector interfaces, the surface having a first end, a second end, and a distance between the first and second ends. The body includes an opening extending between the first connector interface and the second connector interface by an opening length, where the opening is for receiving an optical fiber. The body includes two grooves. A first groove in the body extends between the first connector interface and the second connector interface and along a first portion of the surface between the first end of the surface and a plane substantially perpendicular to and axially aligned with the opening length. The first groove extends into the body by a first depth. A second groove in the body extends between the first connector interface and the second connector interface and along a second portion of the surface between the second end of the surface and the plane substantially perpendicular to and axially aligned with the opening length. The second groove extends into the body by a second depth. The first depth may be different from the second depth.

The first and second grooves in the body of the optical connector can allow for the use of alignment elements, such as discrete or integrated alignment pins, that rest in the grooves of the optical connector. The alignment elements may also rest in complementary grooves of an optical bridge structure aligned with the optical connector. By placing alignment elements in the first and second grooves of the optical connector (e.g., the alignment elements in the grooves being recessed from the surface of the body), the profile or footprint of the alignment elements may be lessened. In contrast with the pin and hole alignment structures described above, the first and second grooves of the example optical connector can have lessened contact with alignment elements (e.g., over one or more surfaces of a groove rather than over a side wall of a hole), which can limit risk of wear or damage to the alignment elements, the grooves, or to the optical connector or optical bridge structure. The alignment elements can be selected or configured (e.g., with a wear-resistant or low friction material or coating) such that the risk of wear or damage to the alignment elements, the grooves, the optical connector, or the optical bridge structure may be minimized. The differing depths of the first and second grooves in the body of the optical connector can allow for the use of alignment elements (e.g., such as the pins described above) to be physically constrained or restricted in movement in different ways. Such an arrangement may allow for relative movement between the optical connector and optical bridge structure to be constrained or limited along multiple degrees of freedom, thereby minimizing risk of misalignment (e.g., due to vibrations or shaking, collisions with other components, impacts, or other disturbances). An optical connector holder may be used to hold or support the optical connector structure and/or optical alignment elements such that the optical structure and optical alignment elements are aligned relative to one another. The optical connector holder may include alignment structures (e.g., grooves) that can accommodate the alignment elements, similarly to the optical bridge structure and the optical connector. The optical connector holder may also aid in alignment of the optical bridge structure and the optical connector relative to one another, and help to ensure that one or more optical paths between openings of the optical bridge structure and optical connector can be reliably established.

In the following detailed description, reference is made to the accompanying drawings that form a part hereof wherein like numerals designate like parts throughout, and in which is shown, by way of illustration, embodiments that may be practiced. It is to be understood that other embodiments may be utilized, and structural or logical changes may be made, without departing from the scope of the present disclosure. Therefore, the following detailed description is not to be taken in a limiting sense.

Any of the features discussed with reference to any of accompanying drawings herein may be combined with any other features to form an optical assembly (such as the optical assembly referenced by one of the reference numerals 100, 200, 600, 800, 900, 1300, 1400, 1700 as described further below, or another optical assembly disclosed herein), a sub-assembly or component(s) of an optical assembly (such as an optical connector, an optical connector holder, or an optical bridge structure), a microelectronic package 1900, or a photonic device 2000, as appropriate. A number of elements of the drawings with same reference numerals may be shared between different drawings; for ease of discussion, a description of these elements provided with respect to one of the drawings may not repeated for the other drawings, and these elements may take the form of any of the embodiments disclosed herein. The drawings are not necessarily to scale. Although some of the drawings illustrate rectilinear structures with flat walls/surfaces and right-angle corners, this is simply for ease of illustration and may not reflect real-life process limitations which may cause various features to not look so “ideal” when any of the structures described herein are examined using e.g., microscopy images. In such images of real structures, possible processing defects could also be visible, e.g., not-perfectly straight edges of materials, tapered vias or other openings, inadvertent rounding of corners or variations in thicknesses of different material layers. There may be other defects not listed here but that are common within the field of semiconductor device fabrication and packaging. Inspection of layout and mask data and reverse engineering of parts of a device to reconstruct a circuit using e.g., optical microscopy or transmission electron microscopy, and/or inspection of a cross-section of a device to detect the shape and the location of various device elements described herein using, e.g., Physical Failure Analysis (PFA) would allow determination of presence of optical connectors as described herein.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). When used to describe a range of dimensions, the phrase “between X and Y” represents a range that includes X and Y. When used to describe a location of an element, the phrase “between X and Y” represents a region that is spatially between element X and element Y. The terms “substantially,” “close,” “approximately,” “near,” and “about,” generally refer to being within +/−20%, e.g., within +/−5% or within +/−2%, of a target value based on the context of a particular value as described herein or as known in the art. Similarly, terms indicating orientation of various elements, e.g., “coplanar,” “perpendicular,” “orthogonal,” “parallel,” or any other angle between the elements, generally refer to being within +/−10%, e.g., within +/−5% or within +/−2%, of the exact orientation.

The description uses the phrases “in an embodiment” or “in embodiments,” which may each refer to one or more of the same or different embodiments. Furthermore, the terms “comprising,” “including,” “having,” and the like, as used with respect to embodiments of the present disclosure, are synonymous. As used herein, the terms “package” and “integrated circuit (IC) package” are synonymous, as are the terms “die” and “IC die.” Furthermore, the terms “chip,” “chiplet,” “die,” and “IC die” may be used interchangeably herein. Although certain elements may be referred to in the singular herein, such elements may include multiple sub-elements. For example, “an insulator material” may include one or more insulator materials.

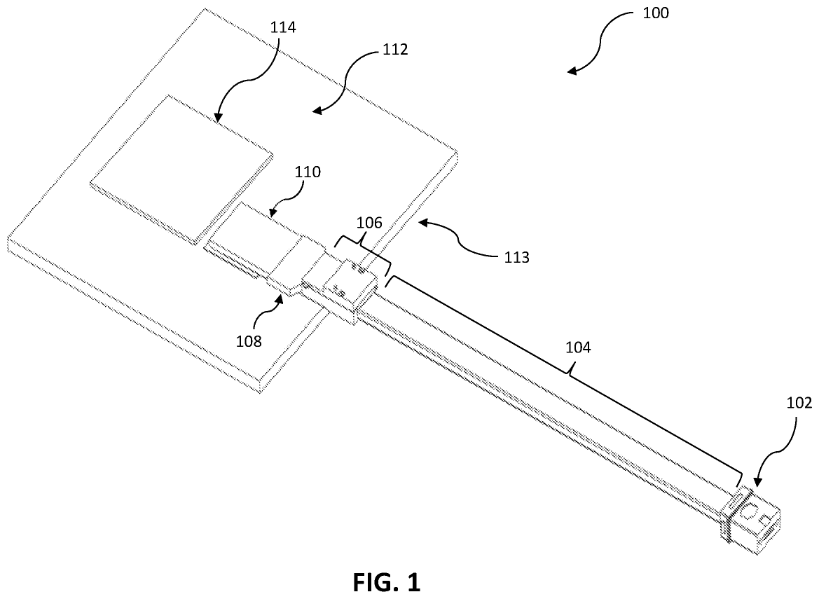

FIG. 1 shows a perspective view of an example optical assembly 100, in accordance with some embodiments. The optical assembly 100 may include an external device coupler 102 configured to join with an external device or component (e.g., an external optical component that can transmit or relay optical signals (e.g., light) to the external device coupler 102, and/or receive optical signals). The external device coupler 102 may be coupled to an FAU 104 that may channel or relay optical signals from the external device coupler 102 to an optical connector assembly 106. The FAU 104 may include a set of fibers that may be in a protective shell or cover. The optical connector assembly 106 may be coupled to an optical bridge structure 108 (e.g., an optical coupler or optical waveguide structure), which may include one or more channels or waveguides along which optical signals can be channeled or relayed from the optical connector assembly 106 to an optical component 110 (e.g., a PIC die, a receiving component associated with a PIC die, etc.). The optical component 110 is over, and may be mounted to or joined with, a substrate 112 (e.g., a package substrate or PIC substrate). One or more other components 114 (e.g., an xPU such as a central processor unit (CPU), a graphics processing unit (GPU), a tensor processing unit (TPU), a data processing unit (DPU), or another processing unit, a die, or another electronic or photonic component) may also be over the substrate 112. In some embodiments, as shown, part or all of the optical connector assembly 106 may be over an end or edge 113 of the substrate 112, or may be joined or mounted to the end or edge 113 of the substrate 112. In other embodiments, the optical connector assembly 106 may be mounted within the end or edge 113 of the substrate 112, or may be mounted away from the end or edge 113 of the substrate 112. In some embodiments, the optical connector assembly 106 may be attached or mounted to a support outside of the substrate 112.

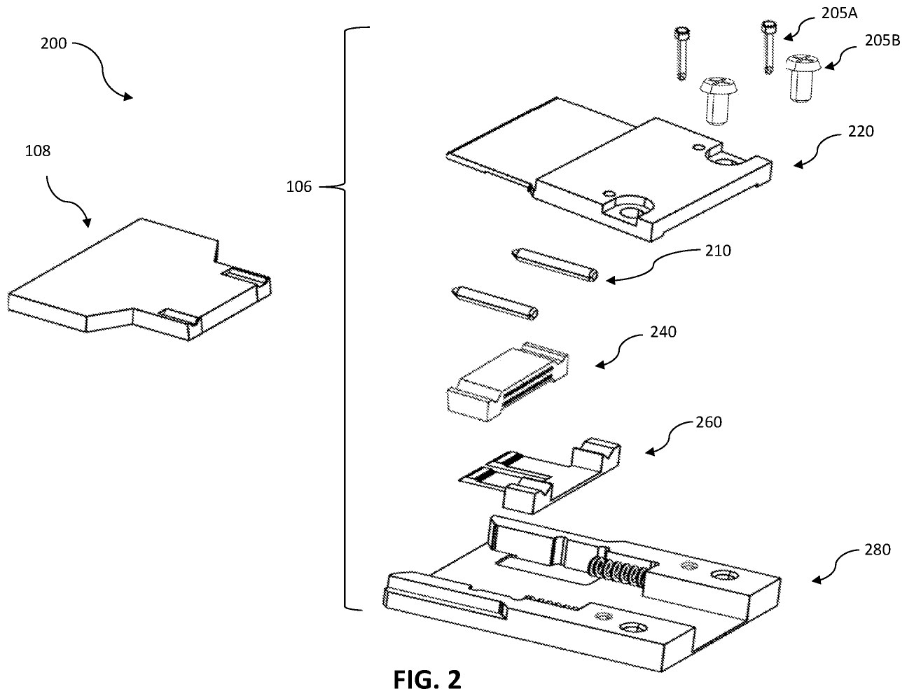

FIG. 2 shows an exploded perspective view of a portion 200 of the example optical assembly 100 of FIG. 1 (the portion 200 also referred to as an optical assembly 200). As shown, the optical assembly 200 may include the optical bridge structure 108 and optical connector assembly 106 shown in FIG. 1. The optical connector assembly 106 may include an optical connector 240. The optical connector 240 may include openings for receiving optical fibers, as described further below. On a first side of the optical connector 240 (e.g., over the optical connector 240) may be alignment elements 210 (e.g., alignment pins) that may be placed in alignment structures (e.g., alignment grooves) of the optical connector 240, as described further below. Additionally, on the first side of the optical connector is a first connector housing portion 220. On a second side of the optical connector 240 (e.g., under the optical connector 240) may be an optical connector holder 260 and a second connector housing portion 280. The first and second connector housing portions 220, 280 may be fastened together through the placement of fasteners 205A, 205B in corresponding fastener receiving structures (e.g., apertures) in the first and second connector housing portions 220, 280. The optical connector 240, alignment elements 210, and optical connector holder 260 may be held within the fastened first and second connector housing portions 220, 280, where the alignment elements 210 may be over the optical connector 240 (e.g., over the alignment structures of the optical connector 240) and the optical connector 240 may be over the optical connector holder 260. As shown in FIG. 1, the first connector housing portion 220 (shown at a top of the assembled optical connector assembly 106 in FIG. 1, or on a side of the optical connector assembly 106 furthest from the substrate 112) and second connector housing portion 280 (shown at a bottom of the assembled optical connector assembly 106 of FIG. 1, or on a side of the optical connector assembly 106 closest to the substrate 112) may be adjacent to the optical bridge structure 108. The optical connector 240 may be aligned with the optical bridge structure 108, and may interface or engage with the optical bridge structure 108 through the alignment elements 210 as described further below.

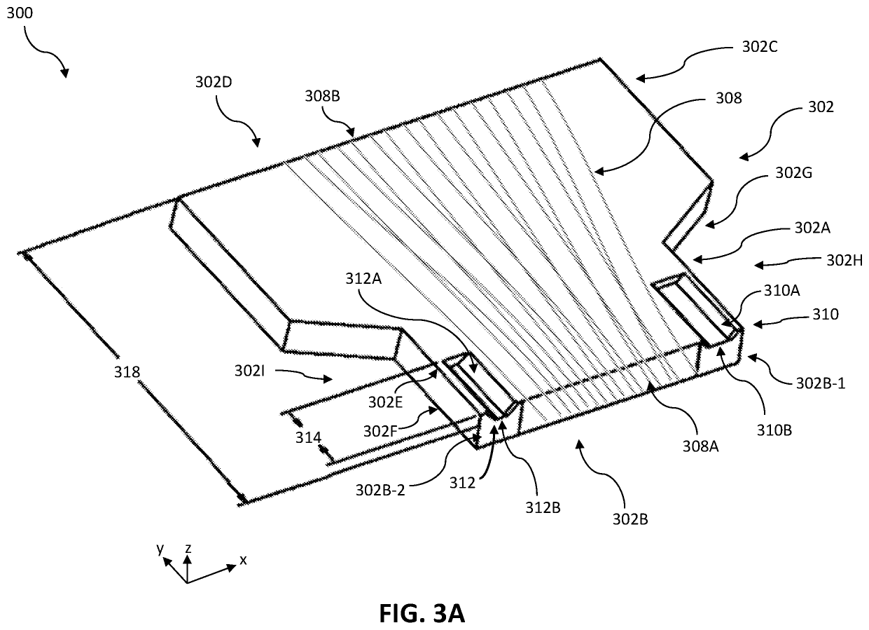

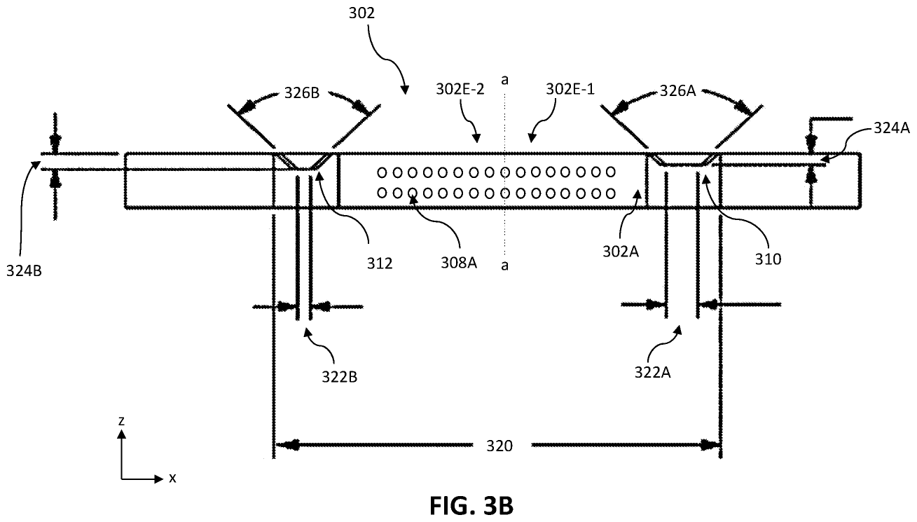

FIG. 3A and FIG. 3B are perspective and front views of an example optical bridge structure 300 (e.g., an optical bridge apparatus, or simply an apparatus), in accordance with some embodiments. The optical bridge structure 300 may be the same as or similar to the optical bridge structure 108 of FIG. 2. The optical bridge structure 300 may include a body 302 including a first portion 302A (e.g., a trailing or rear portion) including a first optical bridge structure interface 302B (e.g., first optical coupler interface or first side) and a second portion 302C (e.g., a leading or front portion) including a second optical bridge structure interface 302D (e.g., a second optical coupler interface or second side). The second optical bridge structure interface 302D may be opposite the first optical bridge structure interface 302B (e.g., may be on an opposite side of the body 302 of the optical bridge structure 300). A first surface 302E (e.g., a top surface) and a second surface 302F (e.g., a bottom surface) may extend between the first optical bridge structure interface 302B and the second optical bridge structure interface 302D. The first optical bridge structure interface 302B may have a width (e.g., along the x-axis as shown in FIG. 3A and FIG. 3B) that is smaller than a width of the second optical bridge structure interface 302D. A transition region 302G extending between the first and second portions 302A, 302C may have a width that increases as the transition region 302G extends from the first portion 302A towards the second portion 302C. In some embodiments, the first optical bridge structure interface 302B and second optical bridge structure interface 302D (and/or the first portion 302A and second portion 302C) may have substantially similar widths, or the first optical bridge structure interface 302B may have a greater width than a width of the second optical bridge structure interface 302D. In some embodiments, no transition region 302G may be included in the optical bridge structure 300.

The optical bridge structure 300 may include optical bridge openings 308 (e.g., optical bridge channels, optical coupler openings, or optical waveguides (or simply waveguides)) extending between the first optical bridge structure interface 302B and the second optical bridge structure interface 302D. The optical bridge openings 308 may include first optical bridge channel opening ends 308A (e.g., along the first optical bridge structure interface 302B) and second optical bridge channel opening ends 308B (e.g., along the second optical bridge structure interface 302D). The optical bridge openings 308 may be channels along which optical signals may be transmitted (e.g., between fibers of the FAU 104 received in the optical connector assembly 106 (e.g., in the optical connector 240 of FIG. 2) and an optical component 110 as shown in FIG. 1).

The optical bridge structure 300 may additionally include a first alignment structure 310 and a second alignment structure 312. The first alignment structure 310 and the second alignment structure 312 may extend from the first optical bridge structure interface 302B towards the second optical bridge structure interface 302D. As shown in FIG. 3A, the first alignment structure 310 and the second alignment structure 312 extend from the first optical bridge structure interface 302B partway to the second optical bridge structure interface 302D. The first alignment structure 310 and/or the second alignment structure 312 may extend from the first optical bridge structure interface 302B towards the second optical bridge structure interface 302D along a length 314. For example, the length 314 may be between about 0.5 mm and about 5 mm, or between about 0.75 mm and about 4 mm, or between about 1 mm and about 3 mm, or any ranges or sub-ranges therebetween. The length 314 may be less than a length 318 of the body 302 of the optical bridge structure 300 (e.g., a length between the first optical bridge structure interface 302B and the second optical bridge structure interface 302D). For example, the length 314 may be between about 5% and about 60% of the length 318, or between about 10% and about 50%, between about 15% and about 40%, or between about 20% and about 30% of the length 318, or any ranges or sub-ranges therebetween. In some embodiments, lengths of the first alignment structure 310 and the second alignment structure 312 may be different. For example, the first alignment structure 310 may be longer than the second alignment structure 312, or the second alignment structure 312 may be longer than the first alignment structure 310.

The first alignment structure 310 and the second alignment structure 312 may extend from a surface of the body 302 (e.g., the first surface 302E) into the body 302 (e.g., along the z-axis as shown in FIG. 3A). The first alignment structure 310 may be closer to the first sidewall 302H than the second sidewall 302I, and the second alignment structure 312 may be closer to the second sidewall 302I than the first sidewall 302H. As shown in FIG. 3A and FIG. 3B, the first alignment structure 310 may extend into the body 302 from a first portion 302E-1 of the first surface 302E (e.g., on a right side of the body 302 in FIG. 3B) between a first end 302B-1 of the first optical bridge structure interface 302B (or a first sidewall 302H (e.g., first end) of the body 302) and a plane a-a substantially perpendicular to and axially aligned with one or more optical bridge openings 308 (e.g., the plane extending “into the page” in FIG. 3B) (e.g. at least a portion of the plane a-a being coaxial with at least one of the optical bridge openings 308). The second alignment structure 312 may extend from a second portion 302E-2 of the first surface 302E (e.g., on a left side of the body 302 in FIG. 3B) between a second end 302B-2 of the first optical bridge structure interface 302B (or a second sidewall 302I (e.g., second end) of the body 302) and the plane a-a. The first end 302B-1 and the second end 302B-2 may be substantially opposed (e.g., may be on opposite sides of the first optical bridge structure interface 302B). The first sidewall 302H and the second sidewall 302I may be substantially opposed (e.g., may be on opposite sides of the body 302).

As shown, the first alignment structure 310 and second alignment structure 312 may be in the form of grooves having a shape of a frustum of a trapezoidal prism (e.g., having a trapezoidal profile with an open top as shown in the front view of FIG. 3B). The first alignment structure 310 may have a pair of first angled portions 310A that extend from the first surface 302E into the body 302, the first angled portions 310A interfacing with a first base portion 310B that is substantially parallel to a portion of the first surface 302E outside of the first alignment structure 310 and the second alignment structure 312. Similarly, the second alignment structure 312 may have a pair of second angled portions 312A that extend from the first surface 302E into the body 302, the second angled portions 312A interfacing with a second base portion 312B that is substantially parallel to a portion of the first surface 302E outside of the first alignment structure 310 and the second alignment structure 312. The first base portion 310B and/or the second base portion 312B may be flat (e.g., have a flat surface), or may be substantially parallel to a flat portion of the first surface 302E.

The first base portion 310B may have a first base portion width 322A, and the second base portion 312B may have a second base portion width 322B. The first base portion width 322A may be greater than the second base portion width 322B. The first base portion width 322A may be, for example, between about 0.1 mm and about 1 mm, or between about 0.2 mm and about 0.8 mm, or between about 0.3 mm and about 0.6 mm, or any ranges or sub-ranges therebetween. The second base portion width 322B may be between about 0.1 mm and about 0.8 mm, or between about 0.1 mm and about 0.6 mm, or between about 0.1 mm and about 0.4 mm, or any ranges or sub-ranges therebetween. The second base portion width 322B may be between about 10% and about 90% of the first base portion width 322A, or between about 20% and about 70%, or between about 30% and about 50% of the first base portion width 322A, or any ranges or sub-ranges therebetween.

An end of the first alignment structure 310 closest to the first end 302B-1 of the first optical bridge structure interface 302B may be a first distance 320 away from an end of the second alignment structure 312 closest to the second end 302B-2 of the first optical bridge structure interface 302B. In some embodiments, the first distance 320 may be between about 2 mm and about 20 mm, or between about 3 mm and about 15 mm, or between about 4 mm and about 10 mm, or between about 5 mm and about 9 mm, or between about 6 mm and about 8 mm, or any ranges or sub-ranges therebetween. The first distance 320 may be between about 50% and about 99% of a length of the first optical bridge structure interface 302B (or, a distance between the first sidewall 302H and the second sidewall 302I), or may be between about 60% and about 90%, or between about 70% and about 80%, or between about 90% and about 99% of the length of the first optical bridge structure interface 302B, or any ranges or sub-ranges therebetween. The first alignment structure 310 may be a second distance from the first end 302B-1 of the first optical bridge structure interface 302B, and the second alignment structure 312 may be a third distance from the second end 302B-2 of the first optical bridge structure interface 302B. The second distance and/or the third distance may be less than or equal to about 3 mm, or less than or equal to about 2 mm, or less than or equal to about 1 mm, or less than or equal to about 0.5 mm, or any ranges or sub-ranges therebetween. The second distance and/or the third distance may be less than or equal to about 25% of a fourth distance between the first end 302B-1 and the second end 302B-2, or may be less than or equal to about 10%, or less than or equal to about 5% of the fourth distance, or any ranges or sub-ranges therebetween. In some configurations, the second distance and the third distance may be substantially similar, or the second distance and the third distance may differ.

The first alignment structure 310 may have a first groove angle 326A, and the second alignment structure 312 may have a second groove angle 326B. The first groove angle 326A and/or the second groove angle 326B may be, for example, between about 0 degrees and about 180 degrees, or between about 20 degrees and about 150 degrees, or between about 40 degrees and about 120 degrees, or between about 60 degrees and about 100 degrees, or any ranges or sub-ranges between. In some embodiments, the first groove angle 326A and the second groove angle 326B may be substantially similar, or the first and second groove angles 326A, 326B may be different. In some embodiments, each of the pair of first angled portions 310A or each of the pair of second angled portions 312A may have the same bevel angle (e.g., an angle between a first or second angled portion 310A, 312A and a plane perpendicular to a corresponding base portion 310B, 312B) or a different bevel angle.

The first alignment structure 310 may have a first depth 324A (e.g., a distance between the first surface 302E and the first base portion 310B) that differs from a second depth 324B of the second alignment structure 312 (e.g., a distance between the first surface 302E and the second base portion 312B). In some embodiments, the first depth 324A may be less than the second depth 324B. The first depth 324A may be, for example, between about 0.4 mm and about 0.05 mm, or between about 0.3 mm and about 0.1 mm, or between about 0.2 mm and about 0.1 mm, or any ranges or sub-ranges therebetween. The second depth 324B may be, for example, between about 0.5 mm and about 0.05 mm, or between about 0.4 mm and about 0.1 mm, or between about 0.3 mm and about 0.1 mm, or any ranges or sub-ranges therebetween. The first depth 324A may be less than or equal to about 90% of the second depth 324B, or less than or equal to about 85%, 80%, 75%, or 70% of the second depth 324B, or any ranges or sub-ranges therebetween. The first depth 324A and/or the second depth 324B may be less than a height of the body 302 of the optical bridge structure 300 (e.g., a distance between the first surface 302E and the second surface 302F). The first depth 324A and/or the second depth 324B may be less than or equal to about 50% of the height of the body 302, or less than or equal to about 40%, 30%, 20%, or 10% of the height of the body 302, or any ranges or sub-ranges therebetween.

Although the first alignment structure 310 and second alignment structure 312 are shown in FIG. 3A and FIG. 3B as grooves having a shape of a frustum of a trapezoidal prism, other shapes for the first alignment structure 310 and second alignment structure 312 are possible. For example, the first alignment structure 310 and the second alignment structure 312 may include groove structures or non-groove structures having hemispherical, spherical, hemicylindrical, or cylindrical shapes, or having shapes of various polyhedral or prismatic structures (e.g., cube, rectangular cuboid or parallelepiped, pyramidal) or frusta thereof. The first alignment structure 310 may have a different shape, geometry, or dimension (e.g., a length, a width, a height, a depth, an angle or angular orientation, etc.) from the second alignment structure 312. In some embodiments, the first alignment structure 310 and the second alignment structure 312 may differ in multiple dimensions (for example, in a first dimension, such as a width or length, and in a second dimension, such as a height or depth).

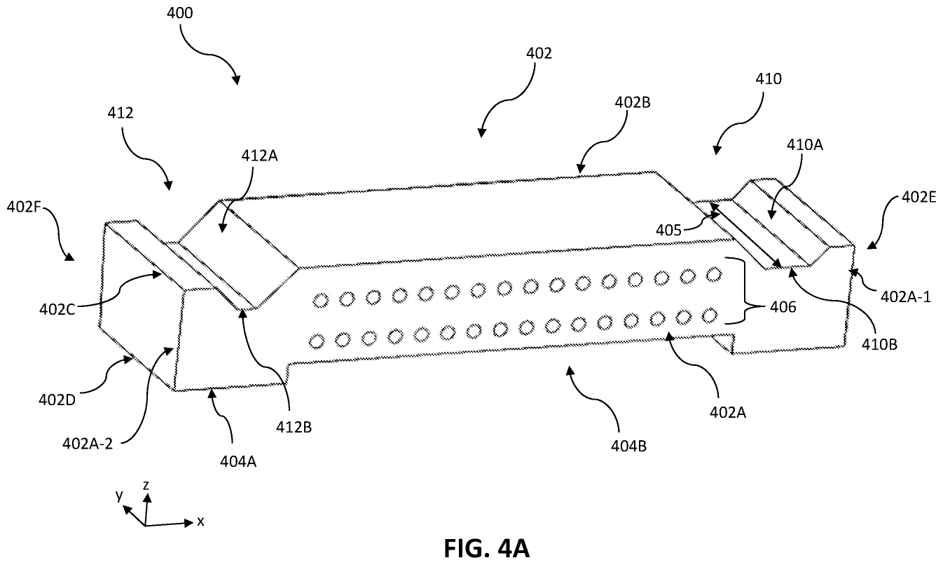

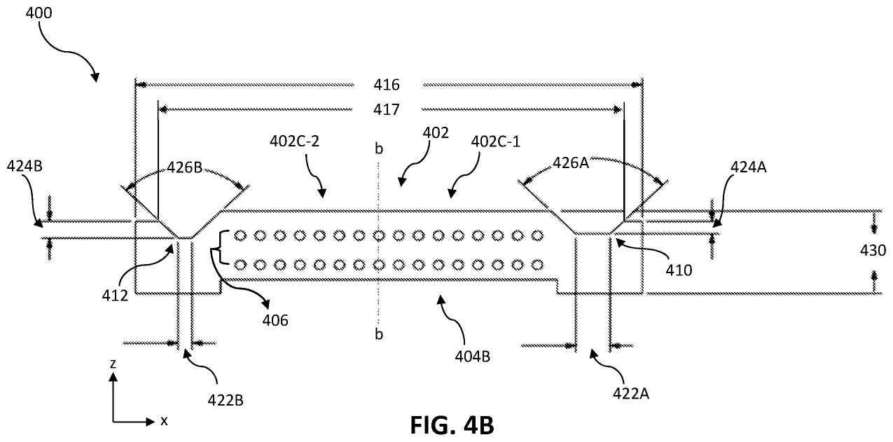

FIG. 4A and FIG. 4B are perspective and front views of an example optical connector 400 (e.g., an optical connector apparatus, or simply a connector or an apparatus), in accordance with some embodiments. The optical connector 400 may be the same as or similar to the optical connector 240 of FIG. 2. The optical connector 400 includes a body 402 including a first optical connector interface 402A (e.g., first side) having a first end 402A-1 and a second end 402A-2, and a second optical connector interface 402B (e.g., second side). The first optical connector interface 402A may be opposite the second optical connector interface 402B (e.g., may be on an opposite side of the body 402 of the optical connector 400). A first surface 402C (e.g., a top surface) and a second surface 402D (e.g., a bottom surface) may extend between the first optical connector interface 402A and the second optical connector interface 402B. The second surface 402D may include supports 404A and a recess 404B (e.g., a step) between the supports 404A that extends into the body 402.

A length of the recess 404B (e.g., between the first end 402A-1 and the second end 402A-2) may be between about 4 mm and about 10 mm, or between about 5 mm and about 9 mm, or between about 6 mm and about 8 mm, or any ranges or sub-ranges therebetween. The length of the recess 404B may be less than a length between the first end 402A-1 and the second end 402A-2. The length of the recess 404B may be between about 50% and about 99% of the length between the first end 402A-1 and the second end 402A-2, or between about 60% and about 90%, or between about 70% and about 80%, or between about 90% and about 99%, or any ranges or sub-ranges therebetween. A first end of the recess 404B may be closer to the first end 402A-1 than the second end 402A-2, and a second end of the recess 404B may be closer to the second end 402A-2 than the first end 402A-1. The first end of the recess 404B may be between about 1% and about 50% of the length between the first end 402A-1 and the second end 402A-2 away from the first end 402A-1, or between about 1% and about 35%, or between about 1% and about 20%, or between about 1% and about 10% of the length between the first end 402A-1 and the second end 402A-2 away from the first end 402A-1. The second end of the recess 404B may be between about 1% and about 50% of the length between the first end 402A-1 and the second end 402A-2 away from the second end 402A-2, or between about 1% and about 35%, or between about 1% and about 20%, or between about 1% and about 10% of the length between the first end 402A-1 and the second end 402A-2 away from the second end 402A-2. The recess may have a depth in the body. The depth may be less than or equal to about 1 mm, or less than or equal to about 0.5 mm, or less than or equal to about 0.3 mm, or less than or equal to about 0.2 mm, or any ranges or sub-ranges therebetween. The depth may be less than or equal to about 50% of a distance between the first surface 402C and the second surface 402D, or less than or equal to about 25%, less than or equal to about 10%, or less than or equal to about 5% of the distance between the first surface 402C and the second surface 402D.

The optical connector 400 may include optical connector openings 406 (e.g., optical connector channels) that extend between the first optical connector interface 402A and the second optical connector interface 402B. The optical connector openings 406 may be for receiving optical fibers, and may be channels along which signals may be transmitted (e.g., between fibers of the FAU 104 and an optical bridge structure, such as the optical bridge structure 300 discussed above). The optical connector 400 may additionally include a first alignment structure 410 and a second alignment structure 412. The first alignment structure 410 and the second alignment structure 412 may extend from the first optical connector interface 402A towards the second optical connector interface 402B. As shown in FIG. 4A, the first alignment structure 410 and the second alignment structure 412 extend between the first optical connector interface 402A and the second optical connector interface 402B along a length 405, which may be substantially the same as a distance between the first optical connector interface 402A and the second optical connector interface 402B. The length 405 may be between about 0.2 mm and about 1.5 mm, or between about 0.4 mm and about 1.2 mm, or between about 0.6 mm and about 0.9 mm, or any ranges or sub-ranges therebetween. The length 405 may be less than a length 416 of the body 402 (e.g., along the x-axis as shown in FIG. 4B). The length 416 of the body 402 may be between about 2 mm and about 10 mm, or between about 3 mm and about 8 mm, or between about 4 mm and about 7 mm, or any ranges or sub-ranges therebetween. The length 405 may be between about 5% and about 80% of the length 416, or between about 15% and about 60%, or between about 25% and about 50%, or any ranges or sub-ranges therebetween. In some embodiments, the first alignment structure 410 and the second alignment structure 412 may have different lengths.

The first alignment structure 410 and the second alignment structure 412 may extend from a surface of the body 402 (e.g., the first surface 402C) into the body 402. In particular, as shown in FIG. 4A and FIG. 4B, the first alignment structure 410 may extend from a first portion 402C-1 of the first surface 402C (e.g., on a right side of the body 402 in FIG. 4B) between the first end 402A-1 of the first optical connector interface 402A (or a first sidewall 402E (or first end) of the body 402) and a plane b-b substantially perpendicular to and axially aligned with one or more of the optical connector openings 406 (e.g., the plane extending “into the page” in FIG. 4B) (e.g., at least a portion of the plane b-b being coaxial with at least one of the optical connector openings 406). The second alignment structure 412 may extend from a second portion 402C-2 of the first surface 402C (e.g., on a left side of the body 402 in FIG. 4B) between a second end 402A-2 of the first optical connector interface 402A (or a second sidewall 402F (or second end) of the body 402) and the plane b-b. The first end 402A-1 and the second end 402A-2 may be substantially opposed (e.g., may be on substantially opposite sides of the first optical connector interface 402A). The first sidewall 402E and the second sidewall 402F may be substantially opposed (e.g., may be on substantially opposite sides of the body 402). The first alignment structure 410 may be closer to the first sidewall 402E than the second sidewall 402F, and the second alignment structure 412 may be closer to the second sidewall 402F than the first sidewall 402E.

As shown, similarly to the first and second alignment structures 310 and 312 of the optical bridge structure 300, the first alignment structure 410 and the second alignment structure 412 of the optical connector 400 may be in the form of grooves. The grooves may have the shape of a frustum of a trapezoidal prism (e.g., having a trapezoidal profile with an open top as shown in the front view of FIG. 4B). The first alignment structure 410 may have a pair of first angled portions 410A that extend from the first surface 402C into the body 402, the first angled portions 410A interfacing with a first base portion 410B that is substantially parallel to a portion of the first surface 402C outside of the first alignment structure 410 and the second alignment structure 412. Similarly, the second alignment structure 412 may have a pair of second angled portions 412A that extend from the first surface 402C into the body 402, the second angled portions 412A interfacing with a second base portion 412B that is substantially parallel to a portion of the first surface 402C outside of the first alignment structure 410 and the second alignment structure 412. The first base portion 410B and/or the second base portion 412B may be flat (e.g., have a flat surface), or may be substantially parallel to a flat portion of the first surface 402C.

The first base portion 410B may have a first base portion width 422A, and the second base portion 412B may have a second base portion width 422B. The first base portion width 422A may be greater than the second base portion width 422B. The first base portion width 422A may be, for example, between about 0.1 mm and about 1 mm, or between about 0.2 mm and about 0.8 mm, or between about 0.3 mm and about 0.6 mm, or any ranges or sub-ranges therebetween. The second base portion width 422B may be between about 0.1 mm and about 0.8 mm, or between about 0.1 mm and about 0.6 mm, or between about 0.1 mm and about 0.4 mm, or any ranges or sub-ranges therebetween. The second base portion width 422B may be between about 10% and about 90% of the first base portion width 422A, or between about 20% and about 70%, or between about 30% and about 50% of the first base portion width 422A, or any ranges or sub-ranges therebetween.

An end of the first alignment structure 410 closest to the first end 402A-1 of the first optical connector interface 402A may be a first distance 417 away from an end of the second alignment structure 412 closest to the second end 402A-2 of the first optical connector interface 402A. In some embodiments, the first distance 417 may be between about 2 mm and about 20 mm, or between about 3 mm and about 15 mm, or between about 4 mm and about 10 mm, or between about 5 mm and about 9 mm, or between about 6 mm and about 8 mm, or any ranges or sub-ranges therebetween. The first distance 417 may be between about 50% and about 99% of the length 416 of the body 402 (or, a length between the first sidewall 402E and the second sidewall 402F), or may be between about 60% and about 90%, or between about 70% and about 80%, or between about 90% and about 99% of the length 416, or any ranges or sub-ranges therebetween. The first alignment structure 410 may be a second distance from the first end 402A-1 of the first optical connector interface 402A, and the second alignment structure 412 may be a third distance from the second end 402A-2 of the first optical connector interface 402A. The second distance and/or the third distance may be less than or equal to about 3 mm, or less than or equal to about 2 mm, or less than or equal to about 1 mm, or less than or equal to about 0.5 mm, or any ranges or sub-ranges therebetween. The second distance and/or the third distance may be less than or equal to about 50% of the length 416 (or, a length between the first sidewall 402E and the second sidewall 402F), or may be less than or equal to 25%, or may be less than or equal to about 10%, or about 5% of the length 416, or any ranges or sub-ranges therebetween. In some configurations, the second distance and the third distance may be substantially similar, or the second distance and the third distance may differ.

The first alignment structure 410 may have a first groove angle 426A, and the second alignment structure 412 may have a second groove angle 426B. The first groove angle 426A and/or the second groove angle 426B may be, for example, between about 0 and about 180 degrees, or between about 20 and about 150 degrees, or between about 40 and about 120 degrees, or between about 60 and about 100 degrees, or any ranges or sub-ranges between. In some embodiments, the first groove angle 426A and the second groove angle 426B may be substantially similar, or the first and second groove angles 426A, 426B may be different. In some embodiments, each of the pair of angled portions 410A (e.g., sidewalls of the alignment structure 410) or each of the pair of angled portions 412A e.g., sidewalls of the alignment structure 412) may have the same bevel angle (e.g., an angle between a first or second angled portion 410A, 412A and a plane perpendicular to a corresponding base portion 410B, 412B) or a different bevel angle. In some embodiments, angles may be between each of the pair of angled portions 410A (e.g., sidewalls of the alignment structure 410) or each of the pair of angled portions 412A e.g., sidewalls of the alignment structure 412) and the first surface 402C. Such angles may be the same, or some such angles may differ from other such angles.

The first alignment structure 410 may have a first depth 424A (e.g., a distance between the first surface 402C and the first base portion 410B) that differs from a second depth 424B of the second alignment structure 412 (e.g., a distance between the first surface 402C and the second base portion 412B). In some embodiments, the first depth 424A may be less than the second depth 424B. The first depth 424A may be, for example, between about 0.4 mm and about 0.05 mm, or between about 0.3 mm and about 0.1 mm, or between about 0.2 mm and about 0.1 mm, or any ranges or sub-ranges therebetween. The second depth 424B may be, for example, between about 0.5 mm and about 0.05 mm, or between about 0.4 mm and about 0.1 mm, or between about 0.3 mm and about 0.1 mm, or any ranges or sub-ranges therebetween. The first depth 424A may be less than or equal to about 90% of the second depth 424B, or less than or equal to about 85%, 80%, 75%, or 70% of the second depth 424B, or any ranges or sub-ranges therebetween. The first depth 424A and/or the second depth 424B may be less than a height 430 of the body 402 of the optical connector 400 (e.g., a distance (e.g., a maximum distance) between the first surface 402C and the second surface 402D). The first depth 424A and/or the second depth 424B may be less than or equal to about 50% of the height 430 of the body 402, or less than or equal to about 40%, 30%, 20%, or 10% of the height 430 of the body 402, or any ranges or sub-ranges therebetween.

Although the first alignment structure 410 and second alignment structure 412 are shown in FIG. 4A and FIG. 4B as grooves having a shape of a frustum of a trapezoidal prism, other shapes for the first alignment structure 410 and second alignment structure 412 are possible. For example, the first alignment structure 410 and the second alignment structure 412 may include groove structures or non-groove structures having hemispherical, spherical, hemicylindrical, or cylindrical shapes, or having shapes of various polyhedral or prismatic shapes (e.g., cube, rectangular cuboid or parallelepiped, pyramidal) or frusta thereof. The first alignment structure 410 may have a different shape, geometry, or dimension (e.g., a length, a width, a height, a depth, an angle or angular orientation, etc.) from the second alignment structure 412. In some embodiments, the first alignment structure 410 and the second alignment structure 412 may differ in multiple dimensions (for example, in a first dimension, such as a width or length, and in a second dimension, such as a height or depth).

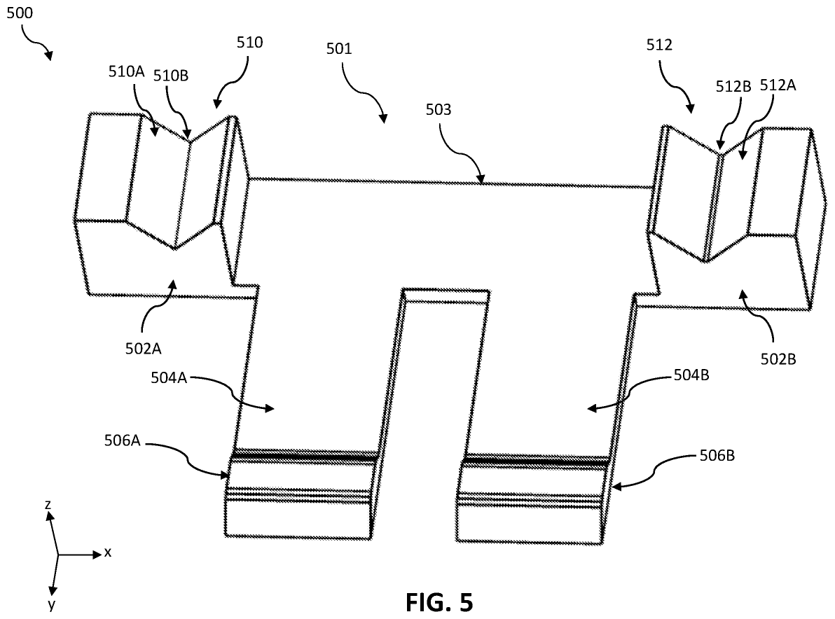

FIG. 5 is a perspective view of an example optical connector holder 500 (e.g., an optical holder apparatus, or simply an apparatus), in accordance with some embodiments. The optical connector holder 500 may be the same as or similar to the optical connector holder 260 shown in FIG. 2. As shown, the optical connector holder 500 may include a body 501 with a substantially planar base 503, a first end pillar 502A, and a second end pillar 502B, the first end pillar 502A and the second end pillar 502B extending from the base 503 in a direction substantially perpendicular to the base 503 (e.g., upwardly along the z-axis as shown in FIG. 5). The first end pillar 502A may include a first alignment structure 510, which may include a pair of sloped segments 510A and a vertex or base 510B between the sloped segments 510A. The second end pillar 502B may include a second alignment structure 512, which may include a pair of sloped segments 512A and a vertex or base 512B between the sloped segments 512A. The body 501 may also include a first biasing arm 504A with a first biasing ridge 506A, and a second biasing arm 504B with a second biasing ridge 506B. The first and second biasing arms 504A may be cantilever arms that extend from portions of base 503 of the body 501, the portions of the base 503 being between the first end pillar 502A and the second end pillar 502B.

FIG. 6 is a perspective view of an assembly 600 including the example optical connector holder 500 of FIG. 5 together with alignment elements 610, in accordance with some embodiments. The alignment elements 610 may be the same as or similar to the alignment elements 210 shown in FIG. 2. As shown, the alignment elements 610 may be pins. The material of the alignment elements 610 may be selected to allow for a high wear resistance or a low coefficient of thermal expansion. The alignment elements 610 may be made of one or more materials including a glass, a metal (such as stainless steel), a resin, an organic material, or an inorganic material. In some embodiments, the alignment elements 610 may include one or more of iron, carbon, cobalt, silicon, chromium, manganese, nickel, or molybdenum. For example, the alignment elements 610 may include an alloy of nickel and iron (for example, about 36% nickel and about 64% iron). As another example, the alignment elements 610 may include an alloy of iron, nickel, and cobalt. The alignment elements 610 may include a coating, which may be wear-resistant or have a low coefficient of thermal expansion or coefficient of friction. The coating may include carbon (e.g., such as diamond-like carbon), or another organic or inorganic material. As shown in FIG. 6, an alignment element 610 can include a shaft 610A. The shaft 610A can have a first end 610B (e.g., a rear end or a back end) including a rounded shape, and a second end 610C, which includes a beveled surface that ends in a tip.

Although the alignment elements 210 shown in FIG. 2 and the alignment elements 610 shown in FIG. 6 are depicted as discrete alignment elements separately formed from other components, in some embodiments, the alignment elements may be integrally formed with (e.g., be a part of) another component. For example, the alignment elements 610 may be integrally formed with the first and second alignment structures 310, 312 of the optical bridge structure 300, the first and second alignment structures 410, 412 of the optical connector 400, or the first and second alignment structures 510, 512 of the optical connector holder 500. In some embodiments, multiple alignment elements may be used (e.g., in a row, or side-by-side) in place of one alignment element. For example, although FIG. 6 shows that one alignment element 610 may be in the first alignment structure 510 of the optical connector holder 500, two or more alignment elements 610 (e.g., in a row, or side-by-side) may be used. Such multiple alignment elements may be fixed or coupled together (e.g., by adhesives, interlocking mechanical features, or by other means).

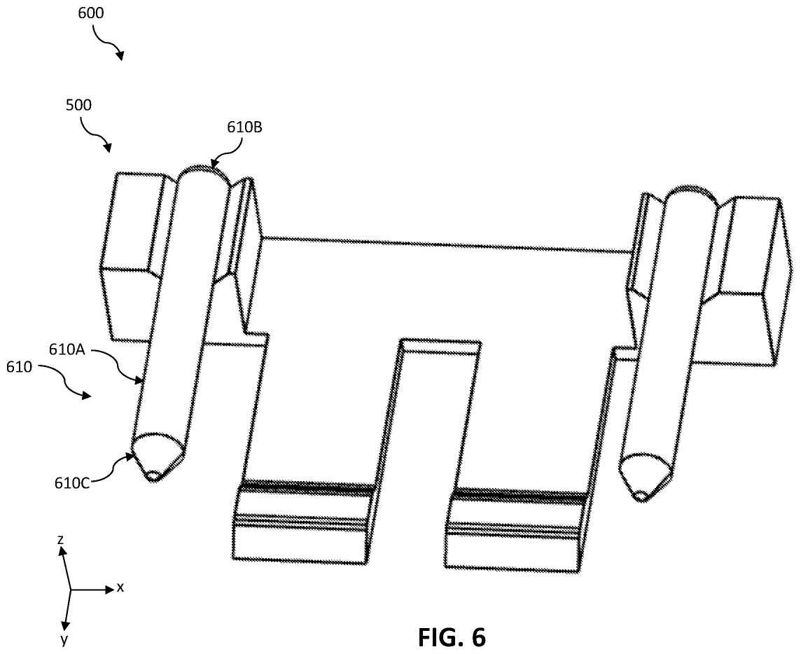

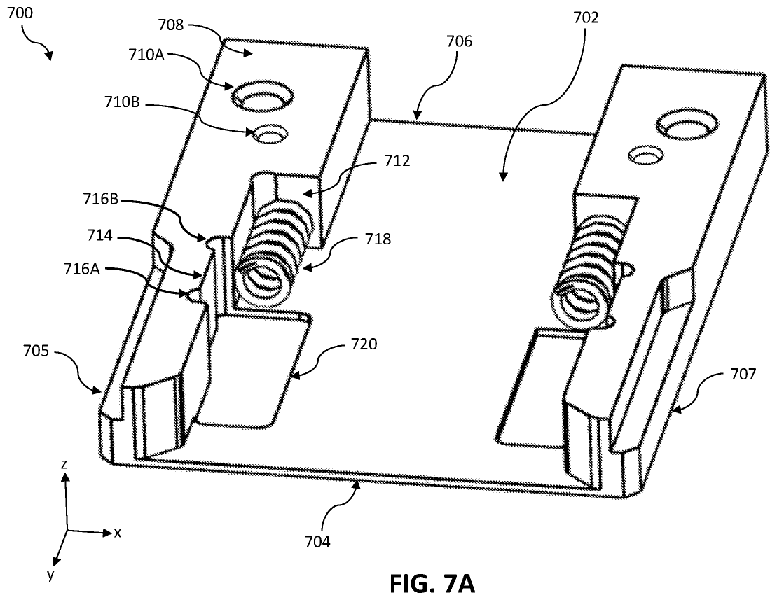

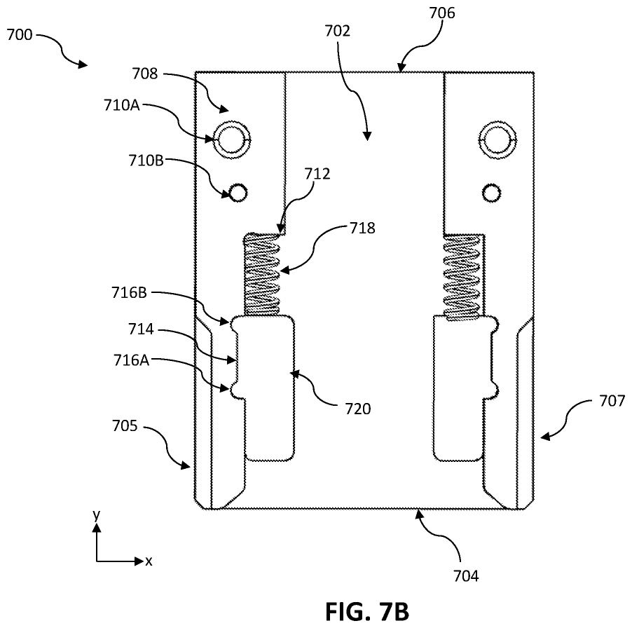

FIGS. 7A and 7B are perspective and plan views, respectively, of an example optical connector housing 700 (e.g., an optical housing apparatus, or simply an apparatus), in accordance with some embodiments. The optical connector housing 700 may be the same as or similar to the second optical connector housing portion 280 shown in FIG. 2. The optical connector housing 700 may include a platform 702 (e.g., a rectangular platform) having a first end 704 (e.g., a leading end or a front end), a second end 706 (e.g., a trailing end or a back end), and sides 705, 707. A pair of shelves 708 may extend upwardly (e.g., along the z-axis in FIG. 7A) from the sides 705, 707. The shelves 708 may include fastener apertures 710A, 710B (e.g., for accepting the fasteners 205A, 205B described above with reference to FIG. 2). The shelves 708 may also first include side walls 712 along which resilient or biasing members 718 (e.g., springs, or other biasing or resilient structures) may be placed. The shelves 708 may also include second side walls 714 which may include first notches 716A and second notches 716B, the first notches 716A being closer to the first end 704 than the second notches 716B, and the second notches 716B being closer to the second end 706 than the first notches 716A. The first and second notches 716A, 716B may be used to restrict the movement of an optical connector holder (e.g., the optical connector holder 500 described above with reference to FIG. 5), as described further below. The platform 702 may further include cut-outs 720. The cut-outs 720 may be used to accommodate a portion of the optical connector (e.g., the optical connector 400 described above with reference to FIG. 4A and FIG. 4B), as described further below.

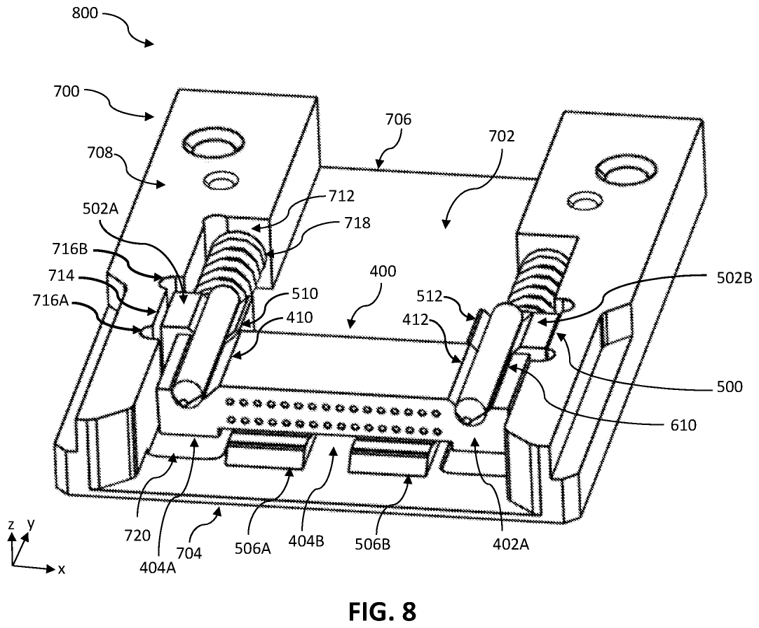

FIG. 8 is a perspective view of an example optical assembly 800, in accordance with some embodiments. The optical assembly 800 includes the optical connector 400 (described above with reference to FIG. 4A and FIG. 4B), the optical connector holder 500 (described above with reference to FIG. 5), the alignment elements 610 (described above with reference to FIG. 6), and the optical connector housing 700 (described above with reference to FIG. 7). As shown, the optical connector 400 may be over the platform 702 of the optical connector housing 700, and may be between the shelves 708 of the optical connector housing 700. The supports 404A of the second surface 402D of the optical connector 400 may extend in or through the cut-outs 720 of the platform 702. The optical connector holder 500 may abut the optical connector 400 such that the first alignment structure 410 of the optical connector 400 is aligned with the first alignment structure 510 of the optical connector holder 500, and such that the second alignment structure 412 of the optical connector 400 is aligned with the second alignment structure 512 of the optical connector holder 500. The alignment elements 610 may extend over the aligned first alignment structures 410, 510 and the aligned second alignment structures 412, 512. The first and second end pillars 502A, 502B of the optical connector holder 500 may be adjacent to the second side walls 714 of the shelves 708, and the optical connector holder 500 may abut the biasing members 718 along the first side walls 712 of the shelves 708. The biasing members 718 may move (e.g., compress or expand) to permit the optical connector holder 500 to move between a first position (where a portion of the optical connector holder 500 abuts the first notches 716A of the second side walls 714) and a second position (where a portion of the optical connector holder 500 abuts the second notches 716B of the second side walls 714). The biasing arms 504A, 504B of the optical connector holder 500 may extend through the recess 404B of the optical connector 400 such that the biasing ridges 506A, 506B of the biasing arms 504A, 504B are on the same side of the optical connector 400 as the first optical connector interface 402A.

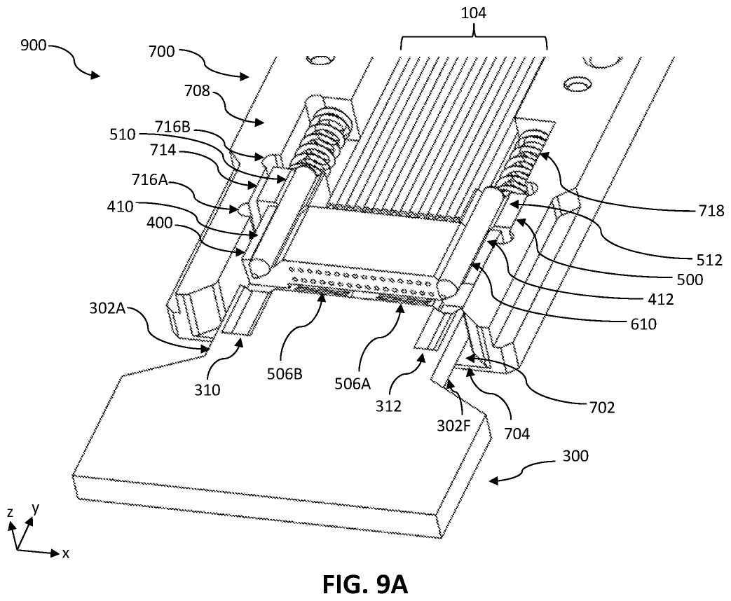

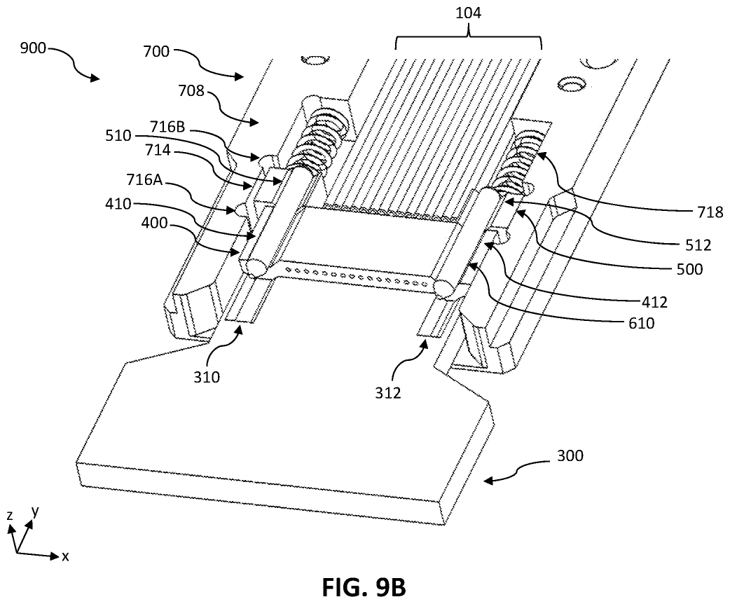

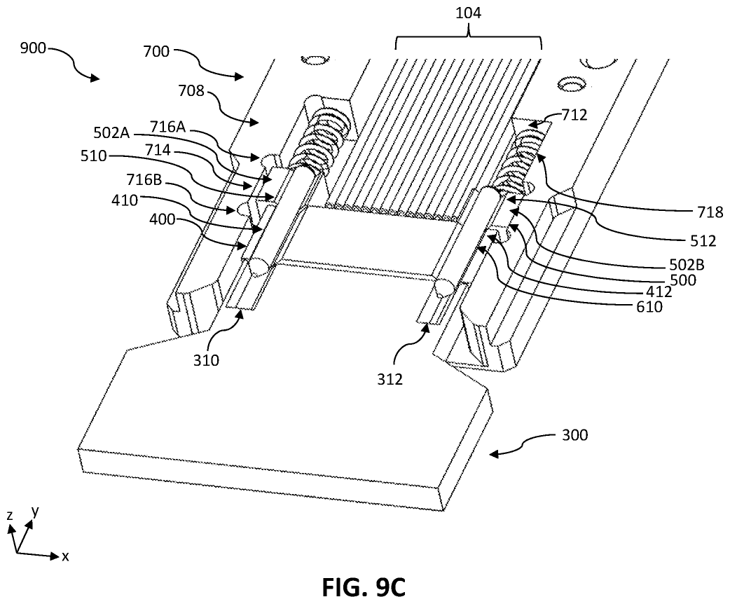

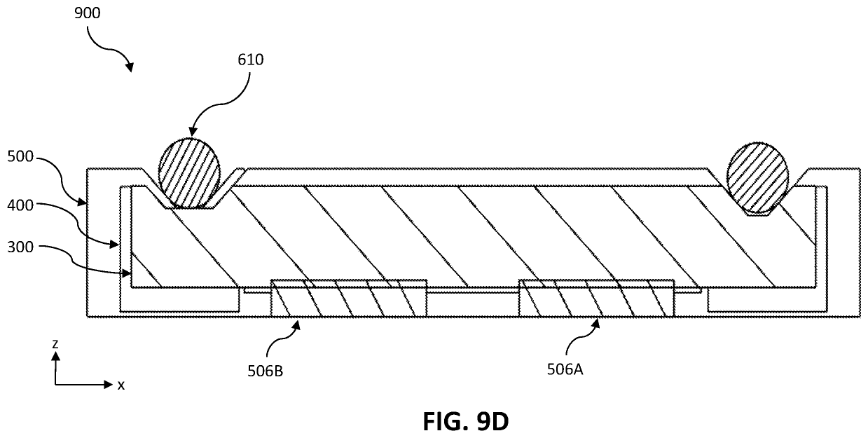

FIGS. 9A-9C are perspective views of an example optical assembly 900, in accordance with some embodiments. In particular, FIG. 9A-9C show stages of an example process in which the example optical assembly 800 of FIG. 8 (including the optical connector 400, the optical connector holder 500, the alignment elements 610, and the optical connector housing 700) may interface with the optical bridge structure 300 (described above with reference to FIG. 3A and FIG. 3B) and the FAU 104 to form the example optical assembly 900. FIG. 9D shows a front view of the example optical assembly 900, omitting the optical connector housing 700.

As shown in FIG. 9A, the first portion 302A of the optical bridge structure 300 may be positioned over the platform 702 of the optical connector housing 700 and between the shelves 708. The optical bridge structure 300 may be positioned between the shelves 708 such that the first and second alignment structures 310, 312 of the optical bridge structure 300 may be aligned (e.g., along the x-axis and the z-axis as shown in FIG. 9A) with the first and second alignment structures 410, 412 of the optical connector 400 and with the first and second alignment structures 510, 512 of the optical connector holder 500. The biasing ridges 506A, 506B of the biasing arms 504A, 504B of the optical connector holder 500 may abut the second surface 302F of the optical bridge structure 300. The fibers of the FAU 104 may be placed in the optical connector openings 406 of the optical connector 400.

As shown in FIG. 9B, the optical bridge structure 300 is closer to the optical connector 400. As shown in FIG. 9C, the optical bridge structure 300 abuts the optical connector 400. As the optical bridge structure 300 is urged towards and against the optical connector 400, the optical connector 400 in turn may push against the optical connector holder 500. The optical connector holder 500 in turn may move against the biasing members 718 along the first side walls 712 of the shelves 708 of the optical connector housing 700. The biasing members 718 may permit the optical connector holder 500 to move towards the second position (where a portion of the optical connector holder 500 abuts the second notches 716B), and in turn may apply a force to the optical connector holder 500 that in turn may urge the optical connector holder 500 against the optical connector 400, and may urge the optical connector 400 against the optical bridge structure 300. As shown in FIG. 9C, the alignment elements 610 may be over the first and second alignment structures 310, 312 of the optical bridge structure 300 in addition to the first and second alignment structures 410, 412 of the optical connector 400 and the first and second alignment structures 510, 512 of the optical connector holder 500. The optical bridge structure 300 may be held in the optical assembly 900 between the alignment elements 610 (over the first and second alignment structures 310, 312 of the optical bridge structure 300) and the biasing ridges 506A, 506B of the biasing arms 504A, 504B of the optical connector holder 500. The optical bridge structure 300 may be positioned between the alignment elements 610 and the biasing ridges 506A, 506B such that the first optical bridge channel opening ends 308A (shown in FIG. 3A) align with the optical connector openings 406 (shown in FIG. 4) (e.g., such that optical axes of the first optical bridge channel opening ends 308A are aligned with optical axes of the optical connector openings 406).

The alignment elements 610 may be constrained in movement by the different geometries or dimensions of the first and second alignment structures 310, 312 of the optical bridge structure 300, and by the different geometries or dimensions of the first and second alignment structures 410, 412 of the optical connector 400. In particular, the alignment elements 610 may be constrained or limited in movement along multiple degrees of freedom at least in part due to the different geometries or dimensions of the first and second alignment structures 310, 410, 312, 412. The constraint or limitation of movement of the alignment elements 610 may limit relative movement between the optical connector 400 and the optical bridge structure 300, and may minimize a risk of misalignment between the optical connector 400 and the optical bridge structure 300 (e.g., due to vibrations or shaking of the optical assembly 900, collisions between the optical assembly 900 with other components, impacts to the optical assembly 900, or other disturbances).

For example, the first base portion width 322A of the first base portion 310B of the first alignment structure 310 may be greater than the second base portion width 322B of the second base portion 312B of the second alignment structure 312, and the first base portion width 422A of the first base portion 410B of the first alignment structure 410 may be greater than the second base portion width 422B of the second base portion 412B of the second alignment structure 412. A first alignment element (of the alignment elements 610) over the relatively wider first base portions 310B, 410B may be restrained between the first angled portions 310A, 410A, the first base portions 310B, 410B, and an optical connector housing cover (e.g., the first connector housing portion 220 shown in FIG. 2, which may be joined with the optical connector housing 700). The first alignment element may be restrained such that it is substantially prevented from rotating or twisting (e.g., around pitch, roll, and/or yaw axes). A second alignment element (of the alignment elements 610) over the relatively narrower second base portions 312B, 412B may be restrained between the second angled portions 312A, 412A, the second base portions 312B, 412B, and the optical connector housing structure top. The second alignment element may be restrained such that it is substantially prevented from moving out of position along the x- or y-axes shown in FIG. 9C.

As another example, the first depth 324A of the first alignment structure 310 may be less than the second depth 324B of the second alignment structure 312, and the first depth 424A of the first alignment structure 410 may be less than the second depth 424B of the second alignment structure 412. A first alignment element (of the alignment elements 610) over the relatively less deep first alignment structures 310, 410 may be restrained between the first angled portions 310A, 410A, the first base portions 310B, 410B, and the optical connector housing structure top. The first alignment element may be restrained such that it is substantially prevented from rotating or twisting (e.g., around pitch, roll, and/or yaw axes). A second alignment element (of the alignment elements 610) over the relatively deeper second alignment structure 312, 412 may be restrained between the second angled portions 312A, 412A, the second base portions 312B, 412B, and the optical connector housing cover. The second alignment element may be restrained such that it is substantially prevented from moving out of position along the x- or y-axes shown in FIG. 9C.

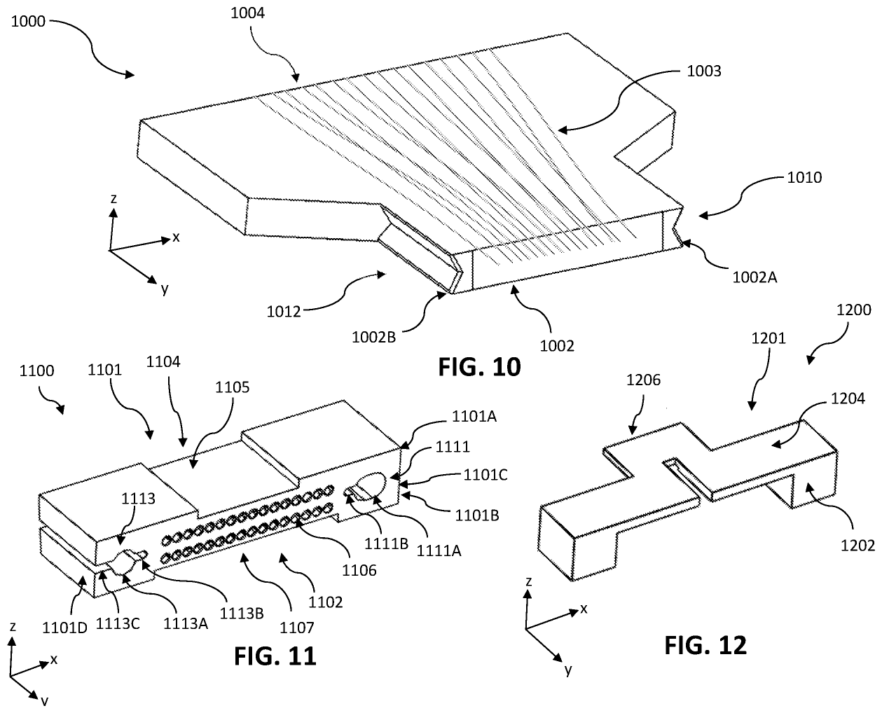

FIG. 10 is a perspective view of an example alternative optical bridge structure 1000 (e.g., an optical bridge apparatus, or simply an apparatus), in accordance with some embodiments. The optical bridge structure 1000 may include a first optical bridge interface 1002 and a second optical bridge interface 1004. Optical bridge openings 1003 (e.g., optical bridge channels, optical coupler openings, or optical waveguides) may extend between the first optical bridge interface 1002 and the second optical bridge interface 1004. The optical bridge structure 1000 may include a first alignment structure 1010 (e.g., a first groove, such as a V-groove) that extends from a first end 1002A of the first optical bridge interface 1002 and towards the second optical bridge interface 1004. The optical bridge structure 1000 may further include a second alignment structure 1012 (e.g., a second groove, such as a V-groove) that extends from a second end 1002B of the first optical bridge interface 1002 towards the second optical bridge interface 1004.

FIG. 11 is a perspective view of an example alternative optical connector 1100 (e.g., an optical connector apparatus, or simply an connector or an apparatus), in accordance with some embodiments. The optical connector 1100 may include a body 1101 including a first optical connector interface 1102 and a second optical connector interface 1104 The first optical connector interface 1102 may be opposite the second optical connector interface 1104 (e.g., may be on an opposite side of the body 1101 of the optical connector 1100). A first surface 1101A (e.g., a top surface), a second surface 1101B (e.g., a bottom surface), a third surface (e.g., a side or lateral surface) 1101C, and a fourth surface (e.g., a side or lateral surface) 1101D may extend between the first optical connector interface 1102 and the second optical connector interface 1104.

The first surface 1101A may include a first recess 1105 (e.g., a first step) between an end of the first surface 1101A facing the third surface 1101C and an end of the first surface 1101A facing the fourth surface 1101D. The second surface 1101B may include a second recess 1107 (e.g., a second step) between an end of the second surface 1101B facing the third surface 1101C and an end of the second surface 1101B facing the fourth surface 1101D. The first recess 1105 may have a smaller length between the third surface 1101C and the fourth surface 1101D than a length of the second recess 1107 between the third surface 1101C and the fourth surface 1101D.

The optical connector 1100 may include optical connector openings 1106 (e.g., optical connector channels) that extend between the first optical connector interface 1102 and the second optical connector interface 1104. The optical connector openings 1106 may be channels along which signals can be transmitted (e.g., between fibers of the FAU 104 and an optical bridge structure, such as the optical bridge structure 1000 described above). The optical connector 1100 may additionally include a first alignment structure 1111 and a second alignment structure 1113. The first alignment structure 1111 may be closer to the third surface 1101C than the second alignment structure 1113, and the second alignment structure 1113 may be closer to the fourth surface 1101D than the first alignment structure 1111.

The first alignment structure 1111 may include an opening 1111A (e.g., a hole, or an opening surrounded by the body 1101) that extends from the first optical connector interface 1102 to the second optical connector interface 1104. The opening 1111A may have a rounded shape, and may have a shape of a substantially cylindrical hole (for example, when viewed from the first optical connector interface 1102 or the second optical connector interface 1104). The opening 1111A may be elongate along the x-axis (e.g., the substantially cylindrical hole may be a substantially elliptic cylindrical hole, or have an ellipse shape). The eccentricity of the opening 1111A may be such that a plane of a major axis of the opening 1111A may intersect with the opening 1113A. A side wall of the opening 1111A may include a recess 1111B that extends from the opening 1111A towards one or more of the optical connector openings 1106.

The second alignment structure 1113 may include an opening 1113A (e.g., a hole) that extends from the first optical connector interface 1102 to the second optical connector interface 1104. The opening 1113A may have a rounded shape, and may have a shape of a substantially cylindrical hole (for example, when viewed from the first optical connector interface 1102 or the second optical connector interface 1104). The opening 1113A may be less eccentric than, or have a lower eccentricity in shape than, the opening 1111A (e.g., when viewed from the first optical connector interface 1102 or the second optical connector interface 1104). A side wall of the opening 1113A may include a first recess 1113B that extends from the opening 1113A towards one or more of the optical connector openings 1106. The side wall of the opening 1113A may also include a second recess 1113C that extends from the opening 1113A to the fourth surface 1101D.

The first alignment structure 1111 may be wider than the second alignment structure 1113. When viewed from the first optical connector interface 1102 or the second optical connector interface 1104 (e.g., along the y-axis as shown in FIG. 11), a cross-section of the first alignment structure 1111 along a plane of the first optical connector interface 1102 or along a plane of the second optical connector interface 1104 may have a larger area than a cross-section of the second alignment structure 1113 along the same plane.

FIG. 12 is a perspective view of an example optical connector holder 1200 (e.g., an optical connector holder apparatus, or simply an apparatus), in accordance with some embodiments. The optical connector holder 1200 includes a body 1201 including a pair of supports 1202 that extend upwardly (e.g., along the z-axis shown in FIG. 12) towards a pair of top surfaces 1204. The top surfaces 1204 extend towards one another (e.g., along the x-axis) and join at a front or leading portion 1206 that is laterally offset (e.g., along the y-axis shown in FIG. 12) from the directions in which the top surfaces 1204 extend towards one another.

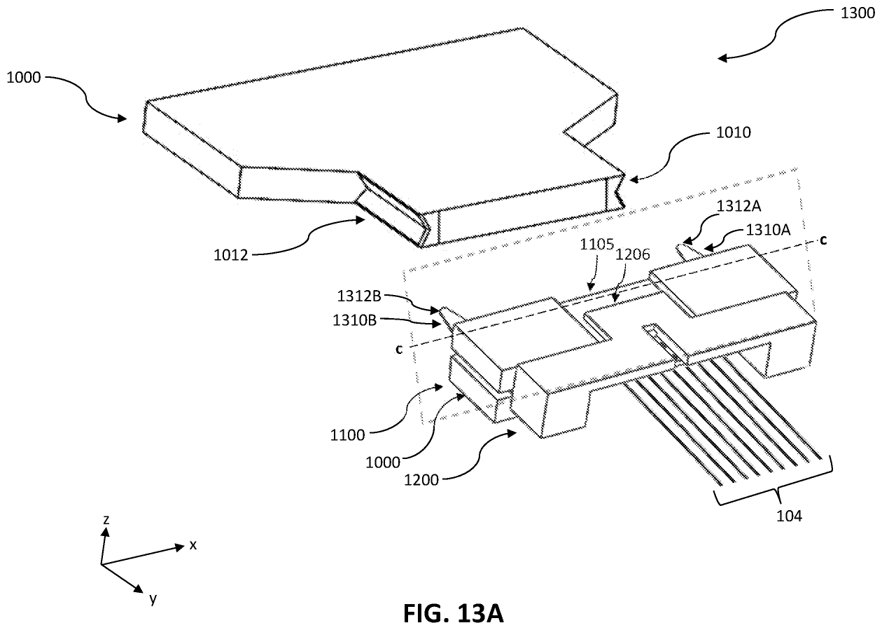

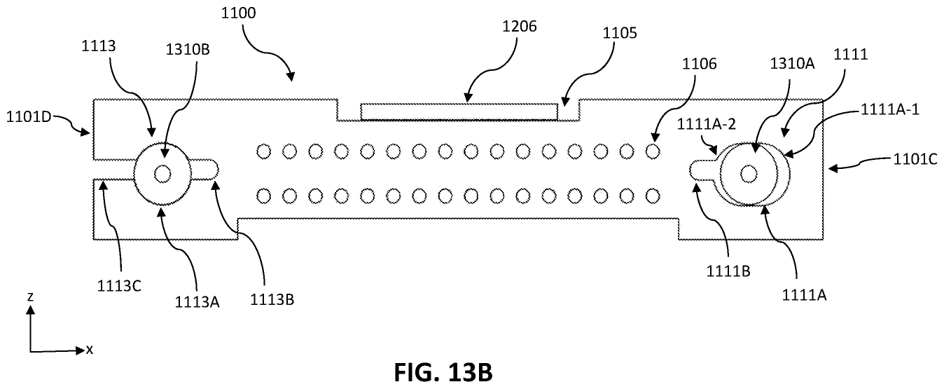

FIG. 13A is a perspective view of an example optical assembly 1300, in accordance with some embodiments, and FIG. 13B is a cross-sectional view of the example optical assembly 1300 of FIG. 13A along plane c-c. In particular, FIG. 13A shows that the optical assembly 1300 includes the optical bridge structure 1000 described above with reference to FIG. 10, the optical connector 1100 described above with reference to FIG. 11, the optical connector holder 1200 described above with reference to FIG. 12, the FAU 104 described above with reference to FIG. 1, a first alignment element 1310A, and a second alignment element 1310B. The first and second alignment elements 1310A, 1310B may be the same as or similar to the alignment elements 610 described above with respect to FIG. 6, and may include tapered or chamfered ends 1312A, 1312B that may be the same as or similar to the second ends 610C of the alignment elements 610 shown in FIG. 6. In FIG. 13A, the optical connector holder 1200 abuts a portion of the first optical connector interface 1102 outside of the optical connector openings 1106. The front or leading portion 1206 of the optical connector holder 1200 may be placed over the first recess 1105 of the optical connector 1100, and optical fibers of the FAU 104 may be placed under the optical connector holder 1200 and in the optical connector openings 1106. The first and second alignment elements 1310A, 1310B may be placed in the first and second alignment structures 1111, 1113 (e.g., in the opening 1111A and in the opening 1113A), such that the tapered or chamfered ends 1312A, 1312B of the first and second alignment elements 1310A, 1310B extend away from the second optical connector interface 1104.

As shown in FIG. 13B, the first alignment element 1310A may be in the first alignment structure 1111 (e.g., in the opening 1111A). As described above, the first alignment structure 1111 may be elongate in the x-axis, and the opening 1111A may have a rounded shape that may be the shape of a substantially elliptic cylindrical hole. The opening 1111A may be wider along the x-axis than a width or diameter of the first alignment element 1310A. The first alignment element 1310A may not be firmly press fit or interference fit in the opening 1111A; rather, the first alignment element 1310A may be permitted to move within the opening 1111A along the x-axis as shown in FIG. 13B. The first alignment element 1310A may move between a first portion 1111A-1 of a side wall of the opening 1111A and a second portion 1111A-2 of the side wall of the opening 1111A, where the first portion 1111A-1 is on a substantially opposed side of the side wall of the opening 1111A from the second portion 1111A-2 (e.g., the first portion 1111A-1 being closer to the third surface 1101C of the optical connector 1100 than the second portion 1111A-2). The first alignment element 1310A may be permitted to move along the x-axis, but may be substantially limited or restricted in motion along other degrees of freedom, such as along the y-axis or along the z-axis, and may be substantially prevented from rotating or twisting (e.g., around pitch, roll, and/or yaw axes) as described further below.

The second alignment element 1310B may be in the second alignment structure 1113 (e.g., in the opening 1113A). As described above, the opening 1113A may have a rounded shape, and may have a shape of a substantially cylindrical hole. The opening 1113A may have a width or diameter that is substantially similar to a width or diameter of the second alignment element 1310B, and the second alignment element 1310B may be press fit or interference fit in the opening 1113A. The second alignment element 1310B may be substantially limited or restricted in motion along multiple degrees of freedom, such as along the x-, y-, or z-axes, and may be substantially prevented from rotating or twisting (e.g., around pitch, roll, and/or yaw axes) as described further below.

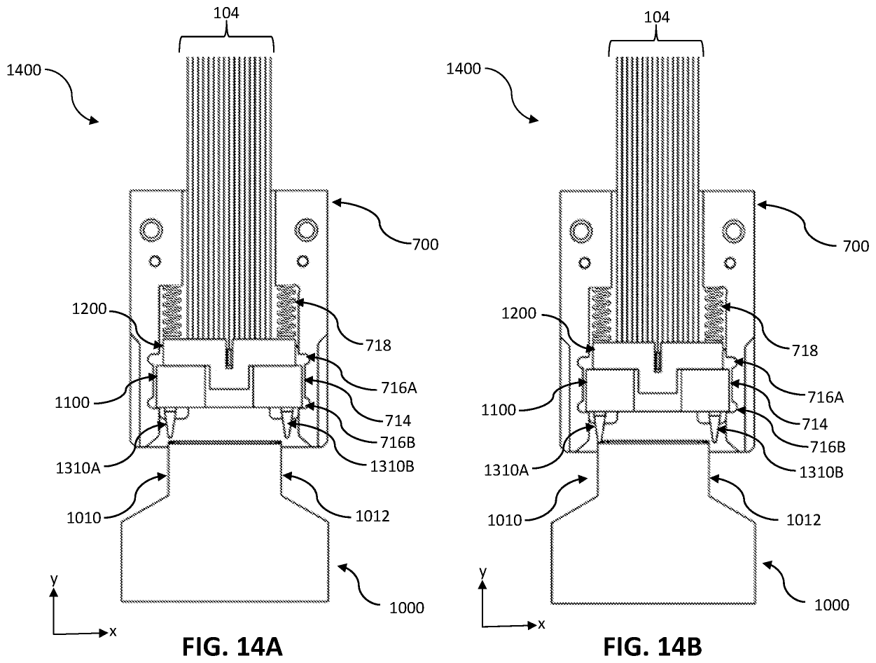

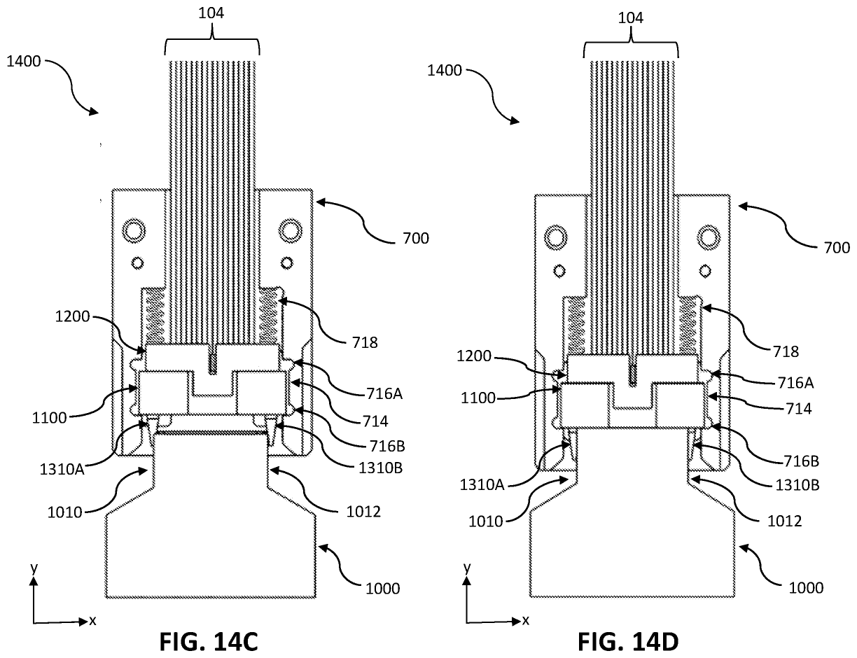

FIGS. 14A-14D are plan views of an example optical assembly 1400, in accordance with some embodiments. In particular, FIG. 14A-14D show stages of an example process in which portions of the example optical assembly 1300 of FIG. 13A and FIG. 13B (including the FAU 104, the optical bridge structure 1000, the optical connector 1100, the optical connector holder 1200, and the first and second alignment elements 1310A, 1310B) may be interfaced. FIG. 14A-14D additionally show the optical connector housing 700, which may be the same as described above. The optical connector 1100, the optical connector holder 1200, and the first and second alignment elements 1310A, 1310B may be over the optical connector housing 700, and an optical connector housing cover (not shown in FIG. 14A-14D; e.g., the first connector housing portion 220 shown in FIG. 2) may be over the optical connector 1100, the optical connector holder 1200, and the first and second alignment elements 1310A, 1310B.

In FIG. 14A, the optical bridge structure 1000 is at a distance from the optical connector 1100, and the optical bridge structure 1000 may not be in contact with the first and second alignment elements 1310A, 1310B. The optical bridge structure 1000 may be moved towards the optical connector 1100. The optical bridge structure 1000 may be oriented such that first alignment structure 1010 and the second alignment structure 1012 may be at substantially similar heights (e.g., along a z-axis extending “into the page” in FIG. 14A) as the first alignment element 1310A and the second alignment element 1310B. The first alignment structure 1010 and the second alignment structure 1012 may be slightly misaligned (e.g., along the x-axis as shown in FIG. 14A) with the first alignment element 1310A and the second alignment element 1310B as the optical bridge structure 1000 is moved towards the optical connector 1100, as described further below.

In FIG. 14B, the optical bridge structure 1000 is closer to the optical connector 1100 than is shown in FIG. 14A. The first alignment element 1310A may contact the first alignment structure 1010. Due to slight misalignment, the second alignment element 1310B does not contact the second alignment structure 1012. As the optical bridge structure 1000 comes closer to the optical connector 1100, the first alignment element 1310A and the first alignment structure 1010 may move (e.g., slide) relative to one another (e.g., along the tapered or chamfered end 1312A of the first alignment element 1310A). As described above, the movement of the first alignment element 1310A may be permitted between the first portion 1111A1-1 and the second portion 1111A-2 of the side wall of the opening 1111A of the optical connector 1100, allowing the first alignment element 1310A to move as force is exerted on the first alignment element 1310A by the first alignment structure 1010.

In FIG. 14C, the optical bridge structure 1000 is closer to the optical connector 1100 than is shown in FIG. 14B. As force is exerted on the first alignment element 1310A by the first alignment structure 1010, an opposed force is exerted by the first alignment element 1310A on the first alignment structure 1010. The opposed force may move the optical bridge structure 1000 along the x-axis such that the first alignment element 1310A may abut and be aligned with the first alignment structure 1010 and the second alignment element 1310B may abut and be aligned with the second alignment structure 1012. In FIG. 14D, the optical bridge structure 1000 is adjacent to the optical connector 1100, and optical bridge structure 1000 is held in place between the first and second alignment elements 1310A, 1310B and between the optical connector housing 700 and the optical connector housing cover (as described above, e.g., the first connector housing portion 220 shown in FIG. 2, not shown in FIG. 14D). After the process of interfacing the optical bridge structure 1000 and the optical connector 1100, the optical bridge openings 1003 may be aligned with the optical connector openings 1106 (e.g., the optical axes of the optical bridge openings 1003 and the optical connector openings 1106 may be aligned).

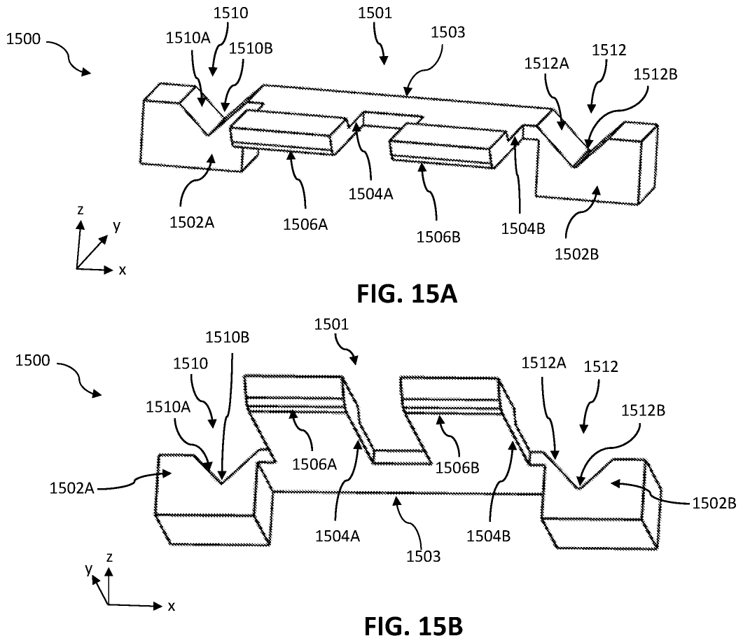

FIGS. 15A and 15B are perspective views of an alternative example of a first component 1500 of an optical connector holder assembly, in accordance with some embodiments. The first component 1500 may include a body 1501 with a substantially planar platform 1503, a first end pillar 1502A, and a second end pillar 1502B, the first end pillar 1502A and the second end pillar 1502B extending from the platform 1503 in a direction substantially perpendicular to the platform 1503 (e.g., downwardly along the z-axis as shown in FIG. 15A). The first end pillar 1502A may include a first alignment structure 1510, which may include a pair of sloped segments 1510A and a vertex or base 1510B between the sloped segments 1510A. The second end pillar 1502B may include a second alignment structure 1512, which may include a pair of sloped segments 1512A and a vertex or base 1512B between the sloped segments 1512A. The body 1501 may also include a first biasing arm 1504A with a first biasing ridge 1506A, and a second biasing arm 1504B with a second biasing ridge 1506B (e.g., the first and second biasing ridges 1506A, 1506B shown at undersides of the first and second biasing arms 1504A, 1504B) in FIG. 15A and FIG. 15B). The first and second biasing ridges 1506A, 1506B may have rounded profiles. The first and second biasing arms 1504A, 1504B may be cantilever arms that extend from portions of the platform 1503 of the body 1501, the portions of the platform 1503 being between the first end pillar 1502A and the second end pillar 1502B.

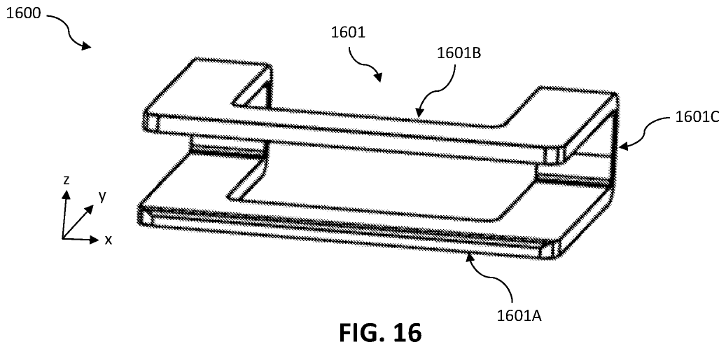

FIG. 16 is a perspective view of an alternative example of a second component 1600 of an optical connector holder assembly, in accordance with some embodiments. The second component 1600 may include a body 1601 with a first substantially U-shaped stage 1601A, and a second substantially U-shaped stage 1601B. The first substantially U-shaped stage 1601A and the second substantially U-shaped stage 1601B may be joined by a set of upward extensions or posts 1601C, such that the second component has a substantially C-shaped profile when viewed along the x-axis.

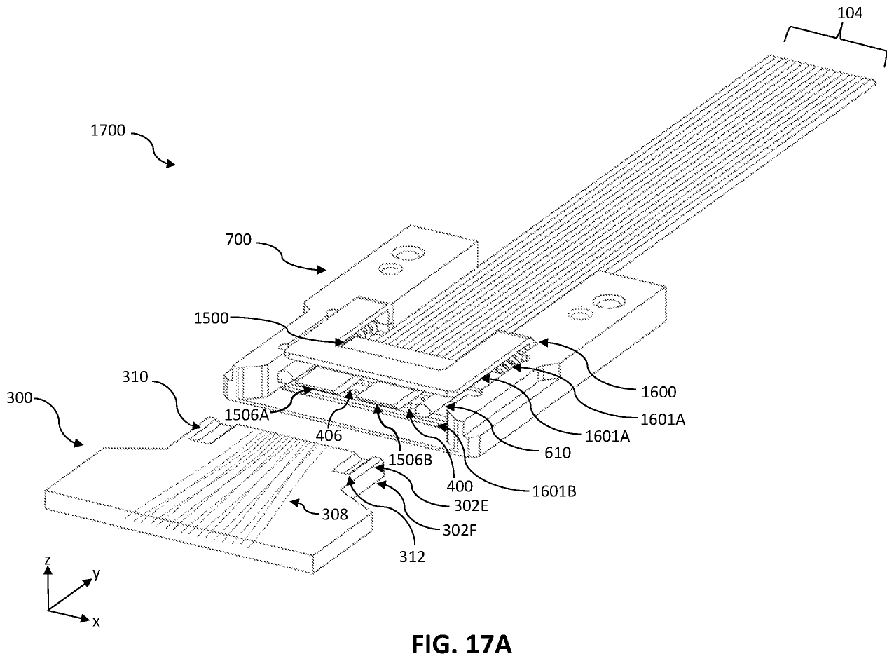

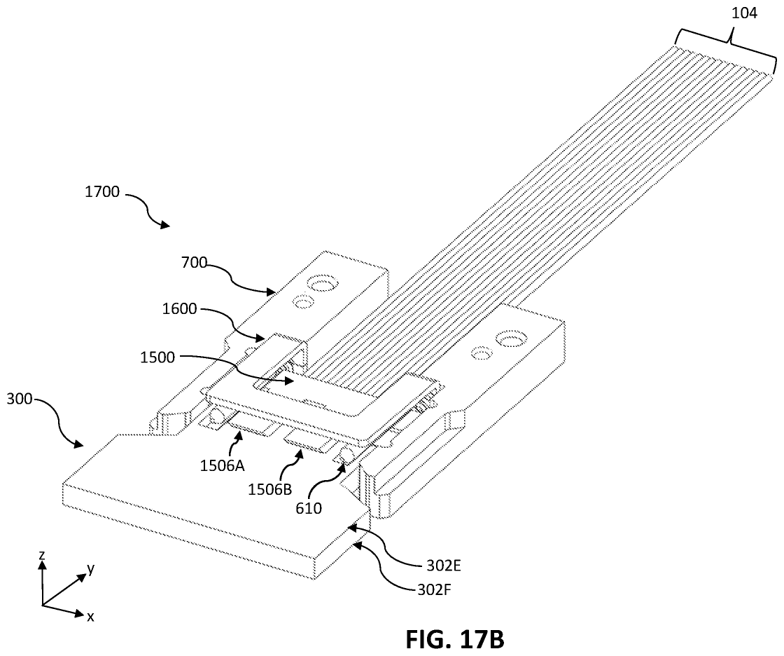

FIGS. 17A and 17B are perspective views of an optical assembly 1700, in accordance with some embodiments. As shown, the optical assembly may include the FAU 104 (described above with reference to FIG. 1), the optical bridge structure 300 (described above with reference to FIG. 3A and FIG. 3B), the optical connector 400 (described above with reference to FIG. 4A and FIG. 4B), the alignment elements 610, the optical connector housing 700 (described above with reference to FIG. 7A and FIG. 7B), and the first and second components 1500, 1600. In particular, FIG. 17A and FIG. 17B show stages of an example process in which the optical bridge structure 300 and the optical connector 400 may be interfaced.

In FIG. 17A, the optical bridge structure 300 is at a distance from the optical connector 400, and the optical bridge structure 300 may not be in contact with the alignment elements 610. The optical bridge structure 300 may be moved toward the optical connector 400. The optical bridge structure 300 may be oriented such that the first alignment structure 310 and the second alignment structure 312 may be at substantially similar heights (e.g., along the z-axis as shown in FIG. 17A) as the first alignment structure 410 and the second alignment structure 412 (not shown in FIG. 17A and FIG. 17B, but shown in FIG. 4A and FIG. 4B). As shown in FIG. 17A, the first component 1500 of the optical connector holder assembly is inside of the second component 1600 of the optical connector holder assembly. In particular, the first component 1500 may be between the first and second substantially U-shaped stages 1601A, 1601B and positioned such that the upward extensions or posts 1601C are over a side of the first component 1500 that faces away from the optical bridge structure 300. The first U-shaped stage 1601A may be over the first and second biasing arms 1504A, 1504B, and the optical connector 400 may be under the first and second biasing arms 1504A, 1504B, and over the second U-shaped stage 1601B.

In FIG. 17B, the optical bridge structure 300 may abut the optical connector 400. The alignment elements 610 may be over the first alignment structures 310, 410 and the second alignment structures 312, 412. The optical bridge structure 300 may be held in place relative to the optical connector 400. In particular, as the optical bridge structure 300 moves towards the optical connector 400, the optical bridge structure 300 may move along the first and second biasing ridges 1506A, 1506B (which may have rounded profiles along which the optical bridge structure 300 can move). After moving along the first and second biasing ridges 1506A, 1506B, the first surface 302E of the optical bridge structure 300 may be pressed down upon by the first and second biasing ridges 1506A, 1506B and the alignment elements 610, which are in turn pressed down upon by the first substantially U-shaped stage 1601A. The second surface 302F of the optical bridge structure 300 may be pressed up upon by the second substantially U-shaped stage 1601B. After the process of interfacing the optical bridge structure 300 and the optical connector 400 (e.g., including placing and holding the optical bridge structure 300 between the first and second biasing ridges 1506A, 1506B, the alignment elements 610, and the second substantially U-shaped stage 1601B), the optical bridge openings 308 (shown in FIG. 17A) may be aligned with the optical connector openings 406 (shown in FIG. 17A). In other words, the optical axes of the optical bridge openings 308 and the optical connector openings 406 may be aligned.

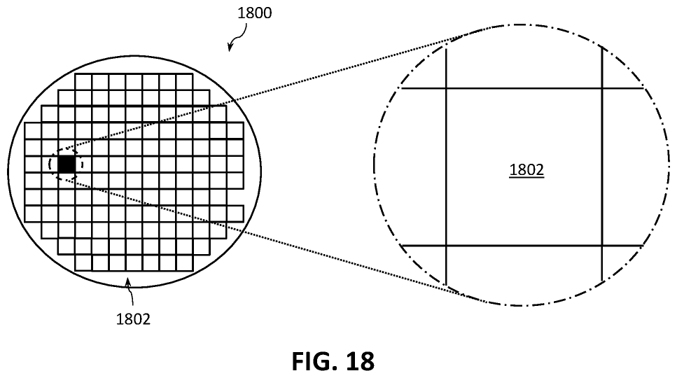

Arrangements with one or more optical assemblies such as the optical assembly referenced by one of the reference numerals 100, 200, 600, 800, 900, 1300, 1400, 1700 as described further below, or another optical assembly disclosed herein, may be included in any suitable component or electronic, photonic, or co-packaged device. Sub-assemblies or components of the optical assemblies disclosed herein (such as an optical connector or an optical bridge structure including alignment features) may also be included in any suitable component or electronic, photonic, or co-packaged device. The optical assemblies and sub-assemblies noted above may be referred to as optical structures hereinafter. FIGS. 18-20 illustrate various examples of devices and components that may include one or more optical structures as disclosed herein.

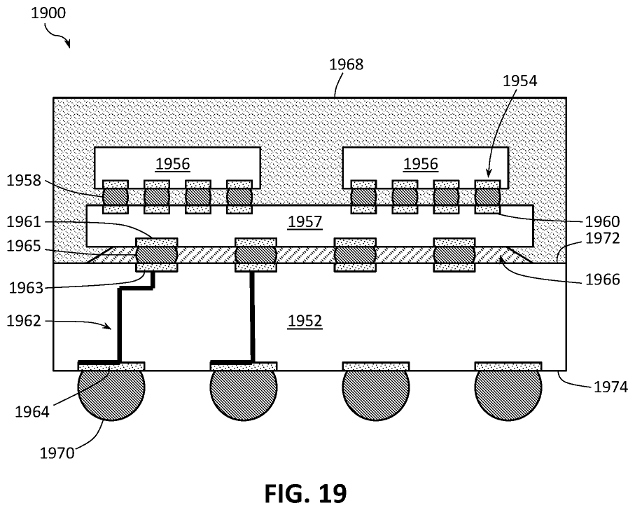

FIG. 18 illustrates top views of a wafer 1800 and dies 1802 that may be included in one or more optical structures in accordance with any of the embodiments disclosed herein. In some embodiments, the dies 1802 may be included in an IC package (e.g., including a PIC package), in accordance with any of the embodiments disclosed herein. For example, any of the dies 1802 may be included in, or serve as, the optical component 110 (e.g., a PIC die) or any of the components 114 shown in FIG. 1. In another example, any of the dies 1802 may serve as any of the dies 1956 in an IC package 1900 shown in FIG. 19. The wafer 1800 may be composed of semiconductor material and may include one or more dies 1802 having IC structures formed on a surface of the wafer 1800. Each of the dies 1802 may be a repeating unit of a semiconductor product that includes any suitable IC (e.g., ICs including one or more PICs as described herein, e.g., the optical component 110 of FIG. 1, or other components 114 of FIG. 1). At least some of the dies 1802 may be attached to, or be included in, one or more optical structures described herein. After the fabrication of the semiconductor product is complete, the wafer 1800 may undergo a singulation process in which each of the dies 1802 is separated from one another to provide discrete “chips” of the semiconductor product. In particular, devices that are attached to, or included in, one or more optical structures as disclosed herein may take the form of the wafer 1800 (e.g., not singulated) or the form of the die 1802 (e.g., singulated). The die 1802 may include supporting circuitry to route electrical and/or optical signals to various components, e.g., to various optical structures, as well as to various transistors, capacitors, resistors, or any other IC components within the die 1802.

FIG. 19 is a side, cross-sectional view of an example microelectronic package 1900 that may include one or more optical structures in accordance with any of the embodiments disclosed herein. In some embodiments, the microelectronic package 1900 may be a system-in-package (SiP).

The package substrate 1952 may be formed of a dielectric material (e.g., a ceramic, a buildup film, an epoxy film having filler particles therein, etc.), and may have conductive pathways 1962 extending through the dielectric material between the face 1972 and the face 1974, or between different locations on the face 1972, and/or between different locations on the face 1974.

The package substrate 1952 may include conductive contacts 1963 that are coupled to conductive pathways 1962 through the package substrate 1952, allowing circuitry within the dies 1956 and/or the interposer 1957 to electrically couple to various ones of the conductive contacts 1964 (or to other devices included in the package substrate 1952, not shown).

The microelectronic package 1900 may include an interposer 1957 coupled to the package substrate 1952 via conductive contacts 1961 of the interposer 1957, first-level interconnects 1965, and the conductive contacts 1963 of the package substrate 1952. The first-level interconnects 1965 illustrated in FIG. 19 are solder bumps, but any suitable first-level interconnects 1965 may be used. In some embodiments, no interposer may be included in the microelectronic package 1900; instead, the dies 1956 may be coupled directly to the conductive contacts 1963 at the face 1972 by first-level interconnects 1965.

The microelectronic package 1900 may include one or more dies 1956 coupled to the interposer 1957 via conductive contacts 1954 of the dies 1956, first-level interconnects 1958, and conductive contacts 1960 of the interposer 1957. The conductive contacts 1960 may be coupled to conductive pathways (not shown) through the interposer 1957, allowing circuitry within the dies 1956 to electrically couple to various ones of the conductive contacts 1961 (or to other devices included in the interposer 1957, not shown). The first-level interconnects 1958 illustrated in FIG. 19 are solder bumps, but any suitable first-level interconnects 1958 may be used. As used herein, a “conductive contact” may refer to a portion of electrically conductive material (e.g., metal) serving as an interface between different components; conductive contacts may be recessed in, flush with, or extending away from a surface of a component, and may take any suitable form (e.g., a conductive pad or socket).

In some embodiments, an underfill material 1966 may be disposed between the package substrate 1952 and the interposer 1957 around the first-level interconnects 1965, and a mold compound 1968 may be disposed around the dies 1956 and the interposer 1957 and in contact with the package substrate 1952. In some embodiments, the underfill material 1966 may be the same as the mold compound 1968. Example materials that may be used for the underfill material 1966 and the mold compound 1968 are epoxy mold materials, as suitable. Second-level interconnects 1970 may be coupled to the conductive contacts 1964. The second-level interconnects 1970 illustrated in FIG. 19 are solder balls (e.g., for a ball grid array arrangement), but any suitable second-level interconnects 1970 may be used (e.g., pins in a pin grid array arrangement or lands in a land grid array arrangement). The second-level interconnects 1970 may be used to couple the microelectronic package 1900 to another component, such as a circuit board (e.g., a motherboard), an interposer, a substrate (e.g., the substrate 112 of FIG. 1), or another IC package, as known in the art.

The dies 1956 may take the form of any of the embodiments of the die 1802 discussed herein. In embodiments in which the microelectronic package 1900 includes multiple dies 1956, the microelectronic package 1900 may be referred to as a multi-chip package (MCP). The dies 1956 may include circuitry to perform any desired functionality. In some embodiments, any of the dies 1956 may be attached to, or included in, one or more optical structures as discussed above; in some embodiments, at least some of the dies 1956 may not be attached to or included in any optical structures.

The microelectronic package 1900 illustrated in FIG. 19 may be a flip chip package, although other package architectures may be used. For example, the microelectronic package 1900 may be a ball grid array (BGA) package, such as an embedded wafer-level ball grid array (eWLB) package. In another example, the microelectronic package 1900 may be a wafer-level chip scale package (WLCSP) or a panel fan-out (FO) package. Although two dies 1956 are illustrated in the microelectronic package 1900 of FIG. 19, a microelectronic package 1900 may include any desired number of the dies 1956. A microelectronic package 1900 may include additional passive components, such as surface-mount resistors, capacitors, and inductors disposed on the first face 1972 or the second face 1974 of the package substrate 1952, or on either face of the interposer 1957. More generally, a microelectronic package 1900 may include any other active or passive components known in the art.

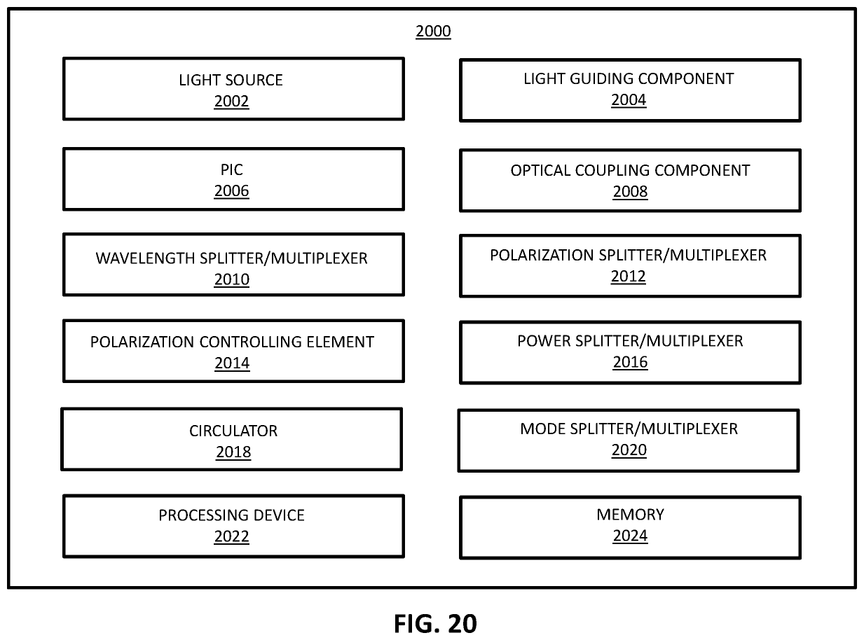

FIG. 20 is a block diagram of an example photonic device 2000 that may include one or more components in which one or more optical structures may be implemented. For example, any suitable ones of the components of the photonic device 2000 may include a die (e.g., the die 1802 of FIG. 18) having one or more microelectronic packages (e.g., microelectronic packages 1900 of FIG. 19).

A number of components are illustrated in FIG. 20 as included in the photonic device 2000, but any one or more of these components may be omitted or duplicated, as suitable for the application. In some embodiments, some or all of the components included in the photonic device 2000 may be attached to one or more motherboards or any suitable support structure. In some embodiments, some or all of these components are fabricated onto a single system-on-chip (SoC) die. Additionally, in some embodiments, the photonic device 2000 may not include one or more of the components illustrated in FIG. 20, but the photonic device 2000 may include interface circuitry for coupling to the one or more components. For example, the photonic device 2000 may not include a processing device 2022, but may include processing device interface circuitry (e.g., a connector and driver circuitry) to which a processing device 2022 may be coupled. In another example, the photonic device 2000 may not include a memory 2024, but may include memory interface circuitry (e.g., connectors and supporting circuitry) to which a memory 2024 may be coupled. In yet another example, the photonic device 2000 may not include a circulator 2018, but may include circulator interface circuitry (e.g., connectors) to which a circulator 2018 may be coupled.

In some embodiments, the photonic device 2000 may include at least one light source 2002. The light source 2002 may include any suitable device for providing the necessary optical signals for various applications of the photonic device 2000, ranging from communication to sensing and imaging. The light source 2002 may be designed to emit light in a controlled and efficient manner to meet the specific requirements of the photonic device 2000. In some embodiment, the light source 2002 may be a coherent and monochromatic light source such as a laser, to produce light of a well-defined wavelength, low divergence, and high brightness. Examples of lasers that may be included in the light source 2002 include semiconductor lasers, such as edge-emitting lasers and vertical-cavity surface-emitting lasers (VCSELs). Such lasers may be particularly advantageous when the photonic device 2000 is used in applications like optical communication, sensing, and laser-based treatments in medical devices. In some embodiment, the light source 2002 may be a non-coherent light source such as a light-emitting diode (LED) that emits light when an electric current is applied. LEDs may be simpler and more cost-effective than lasers, making them suitable for applications where high coherence is not required. Using an LED as the light source 2002 may be particularly advantageous when the photonic device 2000 is used in applications like displays, optical sensors, and short-distance communication systems. In further embodiments, the light source 2002 may include one or more of a superluminescent diode (SLD), a quantum dot, a rare-earth-doped fiber/waveguide, a plasma source (e.g., plasmonics and microplasma devices), a microcavity resonator, or a nonlinear optical device (e.g., a photonic device that uses nonlinear optical processes, such as frequency doubling or parametric amplification, to generate new wavelengths).

In some embodiments, the photonic device 2000 may include at least one light guiding component 2004, such as a waveguide, to manipulate and control the propagation of light. The light guiding component 2004 may include one or more of the optical structures described above. The light guiding component 2004 may include any suitable waveguide structures designed to confine and guide light along a specified path, allowing it to travel from one point to another with minimal loss and dispersion. Examples of waveguides that may be used as the light guiding component 2004 include planar waveguides, optical fibers, photonic crystal waveguides, and rib waveguides. In some embodiments, the light guiding component 2004 may include a material with a higher refractive index, known as the “core,” surrounded by a material with a lower refractive index, known as the “cladding.” The refractive index contrast between the core and cladding helps guide light within the core by using total internal reflection. Light is trapped within the core due to its reflection at the core-cladding interface. The light guiding component 2004 may support various modes of light propagation, such as single-mode or multimode.

In some embodiments, the photonic device 2000 may include at least one PIC 2006 (which may include, for example, the optical component 110). A PIC 2006 may be a miniaturized and integrated optical device that incorporates photonic components, such as optical modulators, photodetectors, and waveguides, onto a single substrate. In some embodiments, the PIC 2006 may include one or more optical modulators for encoding data onto an optical signal, e.g., onto light generated by the light source 2002. An optical modulator of the PIC 2006 may change certain properties of an optical signal, such as its amplitude, frequency, or phase, in order to encode information onto the signal or to perform various signal processing functions. Examples of optical modulators that may be implemented in the PIC 2006 include electro-optic modulators, Mach-Zehnder Interferometric (MZI) modulators, or microring modulators. In some embodiments, the PIC 2006 may include one or more photodetectors for detecting and measuring the intensity of light or optical radiation across various wavelengths by converting incident light/photons into an electrical signal. Examples of photodetectors that may be implemented in the PIC 2006 include photodiodes, avalanche photodiodes, phototransistors, PIN diodes, CMOS image sensors, photomultiplier tubes, or quantum photodetectors. In some embodiments, the PIC 2006 may include one or more waveguides, e.g., any of the waveguides described with reference to the light guiding component 2004.

In some embodiments, the photonic device 2000 may include at least one optical coupling component 2008. The optical coupling component 2008 may include any suitable structures designed to facilitate efficient transfer of light between different optical devices, e.g., between the light source 2002 and the light guiding component 2004, between the light source 2002 and the PIC 2006, between the light guiding component 2004 and the PIC 2006, or between the light guiding component 2004 or the PIC 2006 and a further transmission line such as a fiber (not shown in FIG. 20) that may be coupled to the PIC 2006. Examples of optical coupling elements that may be used to implement the optical coupling component 2008 include fiber couplers (e.g., fused fiber couplers or tapered fiber couplers), waveguide couplers, grating couplers, lens couplers, microlens couplers, prism couplers, fiber array couplers, or ball lens couplers. In some embodiment, the optical coupling component 2008 may include one or more optical structures as described above.

In some embodiments, the photonic device 2000 may include at least one wavelength splitter/multiplexer 2010, to combine or split multiple optical signals that are carried at different wavelengths. This may be particularly advantageous if the photonic device 2000 is used in an optical communication system such as a wavelength division multiplexing (WDM) system or a dense wavelength division multiplexing (DWDM) system, where multiple data channels are transmitted simultaneously over a single optical fiber using different wavelengths of light. In some embodiments, the wavelength splitter/multiplexer 2010 may include a wavelength division multiplexer, a wavelength division demultiplexer, a passive optical add/drop multiplexer, an arrayed waveguide grating, a fused fiber couplers, and interleavers, or an optical filter-based device.

In some embodiments, the photonic device 2000 may include at least one polarization splitter/multiplexer 2012, to combine or split multiple optical signals depending on their polarization. Similarly, in some embodiments, the photonic device 2000 may include at least one polarization controlling component 2014, to control polarization of light generated and manipulated in the photonic device 2000. In some embodiments, a polarization splitter/multiplexer 2012 and a polarization controlling component 2014 may include any suitable structure to enable the manipulation and management of polarized light signals, such as birefringent materials, waveguide structures, or specialized coatings that interact differently with different polarization states.

In some embodiments, the photonic device 2000 may include at least one general power splitter/multiplexer 2016, to combine or split multiple optical signals that in a manner that is not dependent on wavelength or polarization. For example, in some embodiments, a power splitter/multiplexer 2016 may be used to tap off a small amount of optical power for various purposes, such as optical signal or power monitoring in the photonic device 2000. Examples of devices that may be used as a power splitter/multiplexer 2016 include directional couplers and multimode interference couplers.

In some embodiments, the photonic device 2000 may include at least one circulator 2018, also referred to as a “directional splitter.” The circulator 2018 may include any suitable device configured to direct light signals to travel in a specific, one-way circular path through its ports. In some embodiments, the circulator 2018 may include magneto-optic materials or other techniques that create a Faraday rotation effect, where the polarization of light is rotated as it passes through the circulator 2018.

In some embodiments, the photonic device 2000 may include at least one mode splitter/multiplexer 2020, to combine or split multiple optical signals based on their guided modes. Examples of devices that may be used as a mode splitter/multiplexer 2020 include directional couplers, multimode interference couplers, tapered waveguide couplers, photonic lanterns, or photonic crystal splitters.

In some embodiments, the photonic device 2000 may include a processing device 2022 (e.g., one or more processing devices). As used herein, the term “processing device” or “processor” may refer to any device or portion of a device that processes electronic data from registers and/or memory to transform that electronic data into other electronic data that may be stored in registers and/or memory. The processing device 2022 may include one or more digital signal processors (DSPs), application-specific integrated circuits (ASICs), CPUs, GPUS, cryptoprocessors (specialized processors that execute cryptographic algorithms within hardware), server processors, or any other suitable processing devices. In some embodiments, the processing device 2022 may include circuitry to control operation of other components of the photonic device 2000, e.g., to control operation of the PIC 2006.

In some embodiments, the photonic device 2000 may include a memory 2024, which may itself include one or more memory devices such as volatile memory (e.g., DRAM), nonvolatile memory (e.g., read-only memory (ROM)), flash memory, solid state memory, and/or a hard drive. In some embodiments, the memory 2024 may include memory that shares a die with the processing device 2022. This memory may be used as cache memory and may include embedded DRAM (eDRAM) or spin transfer torque magnetic random-access memory (MRAM). In some embodiments, the memory 2024 may store instructions or data for the processing device 2022 to control operation of other components of the photonic device 2000, e.g., to control operation of the PIC 2006.

The following paragraphs provide various examples of the embodiments disclosed herein.

Example 1 provides an optical connector, including a body including a first connector interface, a second connector interface opposite the first connector interface, and a surface between the first connector interface and the second connector interface, the surface having a first end and a second end; an opening in the body (e.g., where the opening is for receiving an optical fiber), the opening having a length (e.g., an opening length) extending between the first connector interface and the second connector interface; a first groove in the body, the first groove extending between the first connector interface and the second connector interface, where the first groove extends from along a first portion of the surface between the first end of the surface and a plane substantially perpendicular to and axially aligned with the opening (e.g., with the opening length), and into the body by a first depth; and a second groove in the body, the second groove extending between the first connector interface and the second connector interface, where the second groove extends from a second portion of the surface between the second end of the surface and the plane substantially perpendicular to and axially aligned with the opening (e.g., with the opening length), and into the body by a second depth, where the first depth is different from the second depth.

Example 2 provides the optical connector of example 1, where the first end of the surface is opposite the second end of the surface.

Example 3 provides the optical connector of examples 1 or 2, where the first groove and the second groove differ in a shape or a geometry.

Example 4 provides the optical connector of any one of examples 1-3, where the first groove and the second groove differ in a length or a width.

Example 5 provides the optical connector of any one of examples 1-4, where the first depth is less than or equal to about 50% of a height of the body.

Example 6 provides the optical connector of example 5, where the second depth is less than or equal to about 50% of the height of the body.

Example 7 provides the optical connector of any of examples 1-6, where the first depth is less than or equal to about 90% of the second depth.

Example 8 provides the optical connector of any one of examples 1-7, where a distance between the first groove and the second groove is between about 4 mm and about 10 mm.

Example 9 provides the optical connector of any one of examples 1-7, where a distance between the first groove and the second groove is between about 50% and about 99% of the distance between the first end and the second end of the surface.

Example 10 provides the optical connector of any one of examples 1-9, where the first groove is less than or equal to about 3 mm from the first end of the surface.

Example 11 provides the optical connector of any one of examples 1-10, where the second groove is less than or equal to about 3 mm from the second end of the surface.

Example 12 provides the optical connector of any one of examples 1-11, where the first groove is less than or equal to about 50% of a distance between the first end and the second end of the surface from the first end of the surface.

Example 13 provides the optical connector of any one of examples 1-12, where the second groove is less than or equal to about 50% of a distance between the first end and the second end of the surface from the second end of the surface.

Example 14 provides the optical connector of any one of examples 1-13, where the first groove has a first groove angle, the second groove has a second groove angle, and the first groove angle is substantially equal to the second groove angle.

Example 15 provides the optical connector of any one of examples 1-14, where a bottom of the first groove is substantially parallel to the surface.

Example 16 provides the optical connector of any one of examples 1-15, where a bottom of the second groove is substantially parallel to the surface.

Example 17 provides the optical connector of any one of examples 1-16, where the surface is a first surface, the body further includes a second surface having a third end and a fourth end, and the optical connector further includes a recess extending from the second surface of the body between the third end and the fourth end and into the body by a third depth.

Example 18 provides the optical connector of example 17, where the first surface is opposite the second surface.

Example 19 provides the optical connector of examples 17 or 18, where a length of the recess is between about 4 mm and about 10 mm.

Example 20 provides the optical connector of examples 17 or 18, where a length of the recess is between about 50% and about 99% of a distance between the third end and the fourth end.

Example 21 provides the optical connector of example 20, where a first end of the recess is between about 1% and about 50% of the distance between the third end and the fourth end from the third end.

Example 22 provides the optical connector of example 21, where a second end of the recess is between about 1% and about 50% of the distance between the third end and the fourth end from the fourth end.

Example 23 provides the optical connector of any one of examples 17-22, where the third depth is less than or equal to about 1 mm.

Example 24 provides the optical connector of any one of examples 17-23, where the third depth is less than or equal to about 50% of a distance between the first surface and the second surface.

Example 25 provides an apparatus (e.g., an optical connector), including a body including a first interface (e.g., a first connector interface) and a second interface (e.g., a second connector interface) opposite the first interface; a first alignment structure in the body, extending between the first interface and the second interface; and a second alignment structure in the body, extending between the first interface and the second interface, where the first alignment structure and the second alignment structure differ in a dimension.

Example 26 provides the apparatus of example 25, where the dimension is a length, width, height, or depth.

Example 27 provides the apparatus of examples 25 or 26, where the first alignment structure and the second alignment structure differ in shape or geometry.

Example 28 provides the apparatus of any one of examples 25-27, where the dimension is a first dimension, the first alignment structure and the second alignment structure further differ in a second dimension, and the second dimension is different from the first dimension.

Example 29 provides the apparatus of any one of examples 25-28, where the body includes a surface between the first interface and the second interface, and where the first alignment structure is an opening extending from the surface into the body (e.g., extending from the surface by a depth into the body).

Example 30 provides the apparatus of example 29, where the depth is less than or equal to about 50% of a height of the body.

Example 31 provides the apparatus of examples 29 or 30, where a bottom of the opening is substantially parallel to the surface.

Example 32 provides the apparatus of any one of examples 29-31, where the opening is a first opening, and the second alignment structure is a second opening in the body.

Example 33 provides the apparatus of example 32, where the depth is a first depth, and the second opening extends from the surface into the body by a second depth.

Example 34 provides the apparatus of example 33, where the first opening and the second opening differ in the dimension by the first depth being different from the second depth.

Example 35 provides the apparatus of example 34, where the first depth is less than or equal to about 90% of the second depth.

Example 36 provides the apparatus of any one of examples 33-35, where a portion of the first opening extends from the surface into the body along a first angle, a portion of the second alignment structure extends from the surface into the body along a second angle, and the first angle is substantially equal to the second angle.

Example 37 provides the apparatus of any one of examples 25-36, where the first alignment structure is closer to a first end of the body than the second alignment structure, and the second alignment structure is closer to a second end of the body than the first alignment structure.

Example 38 provides the apparatus of example 37, where the first end of the body opposes the second end of the body.

Example 39 provides the apparatus of example 32, where the second opening is surrounded by the body.

Example 40 provides the apparatus of example 39, where the first opening includes a first hole, and the second opening includes a second hole.

Example 41 provides the apparatus of example 40, where the first hole and the second hole extend within the body between the first interface and the second interface.

Example 42 provides the apparatus of examples 40 or 41, where, in a cross-section along a plane substantially parallel to the first interface (or the second interface), the first hole has a first area along the plane, the second hole has a second area along the plane, and the first area and the second area differ.

Example 43 provides the apparatus of example 42, where, in a cross-section along the plane substantially parallel to the first interface, at least a portion of the first hole has a first elliptical shape, at least a portion of the second hole has a second elliptical shape, and the second elliptical shape has a higher eccentricity than the first elliptical shape.

Example 44 provides the apparatus of example 43, where a plane of a major axis of the second elliptical shape intersects with the first elliptical shape.

Example 45 provides an optical bridge structure, including a body including a first optical bridge structure interface, a second optical bridge structure interface opposite the first optical bridge structure interface, and a surface between the first optical bridge structure interface and the second optical bridge structure interface, the surface having a first end, a second end, and a distance between the first end and the second end; a waveguide in the body, the waveguide extending between the first optical bridge structure interface and the second optical bridge structure interface by a length (e.g., a waveguide length); a first groove in the body, the first groove extending from the first optical bridge structure interface towards the second optical bridge structure interface, where the first groove extends from a first portion of the surface between the first end of the surface and a plane substantially perpendicular to and axially aligned with the waveguide length, and into the body by a first depth; and a second groove in the body, the second groove extending from the first optical bridge structure interface towards the second optical bridge structure interface, where the second groove extends from a second portion of the surface between the second end of the surface and the plane substantially perpendicular to and axially aligned with the waveguide length, and into the body by a second depth, where the first depth is different from the second depth.

Example 46 provides the optical bridge structure of example 45, where the first groove extends partway between the first optical bridge structure interface and the second optical bridge structure interface.

Example 47 provides the optical bridge structure of example 46, where the second groove extends partway between the first optical bridge structure interface and the second optical bridge structure interface.

Example 48 provides the optical bridge structure of any one of examples 45-47, where the first groove and the second groove differ in shape or geometry.

Example 49 provides the optical bridge structure of any one of examples 45-48, where the first end of the surface and the second end of the surface are substantially opposed.

Example 50 provides the optical bridge structure of any one of examples 45-49, where the first groove and the second groove further differ in a length or a width.

Example 51 provides the optical bridge structure of any one of examples 45-50, where the first depth is less than or equal to about 50% of a height of the body.

Example 52 provides the optical bridge structure of example 51, where the second depth is less than or equal to about 50% of the height of the body.

Example 53 provides the optical bridge structure of any of examples 45-52, where the first depth is less than or equal to about 90% of the second depth.

Example 54 provides the optical bridge structure of any one of examples 45-53, where a distance between the first groove and the second groove is between about 4 mm and about 10 mm.

Example 55 provides the optical bridge structure of any one of examples 45-54, where a distance between the first groove and the second groove is between about 50% and about 99% of the distance between the first end and the second end of the surface.

Example 56 provides the optical bridge structure of any one of examples 45-55, where the first groove is less than or equal to about 3 mm from the first end of the surface.

Example 57 provides the optical bridge structure of any one of examples 45-56, where the second groove is less than or equal to about 3 mm from the second end of the surface.

Example 58 provides the optical bridge structure of any one of examples 45-57, where the first groove is less than or equal to about 50% of the distance between the first end and the second end of the surface from the first end of the surface.

Example 59 provides the optical bridge structure of any one of examples 45-58, where the second groove is less than or equal to about 50% of the distance between the first end and the second end of the surface from the second end of the surface.

Example 60 provides the optical bridge structure of any one of examples 45-59, where the first groove has a first groove angle, the second groove has a second groove angle, and the first groove angle is substantially equal to the second groove angle.

Example 61 provides the optical bridge structure of any one of examples 45-60, where a bottom of the first groove is substantially parallel to the surface.

Example 62 provides the optical bridge structure of any one of examples 45-61, where a bottom of the second groove is substantially parallel to the surface.

Example 63 provides an assembly, including an optical bridge structure, the optical bridge structure including a first body including a first optical bridge structure interface, a second optical bridge structure interface opposite the first optical bridge structure interface, and a first surface between the first optical bridge structure interface and the second optical bridge structure interface, the first surface having a first end and a second end; a waveguide in the first body, the waveguide extending between the first optical bridge structure interface and the second optical bridge structure interface by a first length (e.g., a waveguide length); a first groove in the first body, the first groove extending from the first optical bridge structure interface towards the second optical bridge structure interface, where the first groove extends from a first portion of the first surface between the first end of the first surface and a plane substantially perpendicular to and axially aligned with the first length, and into the first body by a first depth; and a second groove in the first body, the second groove extending from the first optical bridge structure interface towards the second optical bridge structure interface, where the second groove extends from a second portion of the first surface between the second end of the first surface and the plane substantially perpendicular to and axially aligned with the first length, and into the first body by a second depth, where the first depth is different from the second depth, and an optical connector, the optical connector including a second body including a first connector interface, a second connector interface opposite the first connector interface, and a second surface between the first connector interface and the second connector interface, the second surface having a third end and a fourth end; an opening in the second body (e.g., where the opening is for receiving an optical fiber), the opening extending between the first connector interface and the second connector interface by an second length (e.g., an optical connector opening length); a third groove in the second body, the third groove extending between the first connector interface and the second connector interface, where the third groove extends from along a third portion of the second surface between the third end of the second surface and a plane substantially perpendicular to and axially aligned with the second length (at least a portion of the plane being coaxial with the second length), and into the second body by a third depth; and a fourth groove in the second body, the fourth groove extending between the first connector interface and the second connector interface, where the fourth groove extends from a fourth portion of the second surface between the fourth end of the second surface and the plane substantially perpendicular to and axially aligned with the second length, and into the second body by a fourth depth, where the third depth is different from the fourth depth, the first groove is substantially aligned with the third groove, and the second groove is substantially aligned with the fourth groove.

Example 64 provides the assembly of example 63, where the first depth is substantially similar to the third depth, and the second depth is substantially similar to the fourth depth.

Example 65 provides the assembly of examples 63 or 64, where a shape or geometry of the first groove is substantially similar to a shape of the third groove, and a shape or geometry of the second groove is substantially similar to a shape or geometry of the fourth groove.

Example 66 provides the assembly of any one of examples 63-65, further including a pin over the first groove and the third groove.

Example 67 provides the assembly of example 66, where the pin is a first pin, and the assembly further includes a second pin over the second groove and the fourth groove.

Example 68 provides the assembly of any one of examples 63-67, further including a holder element in contact with the optical connector.

Example 69 provides the assembly of example 68, where the holder element includes a third body, a fifth groove in the third body, and a sixth groove in the third body, the fifth groove is substantially aligned with the first groove and the third groove, and the sixth groove is substantially aligned with the second groove and the fourth groove.

Example 70 provides the assembly of examples 68 or 69, where the holder element includes an arm that passes through a recess in the second body of the optical connector.

Example 71 provides the assembly of any one of examples 68-70, where the holder element contacts the optical connector at a first end of the holder element, and the assembly further includes a biasing element at a second end of the holder element, the first end opposed to the second end.

Example 72 provides the assembly of example 71, where the biasing element extends between the second end of the holder element and a housing structure.

Example 73 provides the assembly of any one of examples 68-72, where the holder element exerts a force over the first surface and the second surface.

Example 74 provides an apparatus (e.g., a connector, e.g., an optical connector), including a body including a first interface (e.g., a first connector interface), a second interface (e.g., a second connector interface) opposite the first interface, a surface between the first interface and the second interface, a first sidewall between the first interface and the second interface, and a second sidewall between the first interface and the second interface; a first groove in the surface, where the first groove extends between the first interface and the second interface, and is closer to the first sidewall than to the second sidewall; and a second groove in the surface, where the second groove extends between the first interface and the second interface, and is closer to the second sidewall than to the first sidewall, where a depth of the first groove is different from a depth of the second groove.

Example 75 provides the apparatus of example 74, where the depth of the first groove is less than or equal to about 90% of the depth of the second groove.

Example 76 provides the apparatus of examples 74 or 75, where a width of the first groove is different from a width of the second groove.

Example 77 provides the apparatus of any one of examples 74-76, where an angle between the surface and a sidewall of the first groove is different from an angle between the surface and a sidewall of the second groove.

Example 78 provides the apparatus of any one of examples 74-77, where a distance between the first groove and the second groove is between about 50% and about 99% of the distance between the first sidewall and the second sidewall.

Example 79 provides the apparatus of any one of examples 74-78, where a distance between the first sidewall and the first groove is less than about 50% of a distance between the first sidewall and the second sidewall.

Example 80 provides the apparatus of any one of examples 74-79, where outside of the first groove and the second groove, the surface has a flat portion, and where a bottom of the first groove is substantially parallel to the flat portion of the surface.

Example 81 provides the apparatus of any one of examples 74-80, where the surface is a first surface, the body further includes a second surface, and the apparatus further includes a recess in the second surface of the body.

Example 82 provides the apparatus of any one of examples 74-81, further including a plurality of openings in the body, extending between the first connector interface and the second connector interface.

Example 83 provides an apparatus (e.g., a structure, e.g., an optical bridge structure), including a body including a first interface (e.g., a first optical bridge structure interface), a second interface (e.g., a second optical bridge structure interface) opposite the first interface, a surface between the first interface and the second interface, a first sidewall between the first interface and the second interface, a first sidewall between the first interface and the second interface, and a second sidewall between the first interface and the second interface; a waveguide in the body, the waveguide extending between the first interface and the second interface; a first groove in the surface, the first groove extending from the first interface towards the second interface, the first groove closer to the first sidewall than to the second sidewall, and a second groove in the surface, the second groove extending from the first interface towards the second interface, the second groove closer to the second sidewall than to the first sidewall, where a depth of the first groove is different from a depth of the second groove.

Example 84 provides the structure of example 83, where the first groove extends partway between the first interface and the second interface.

Example 85 provides the structure of examples 83 or 84, where the first groove and the second groove further differ in a length or a width.

1. An apparatus, comprising:
a body comprising a first interface, a second interface opposite the first interface, a surface between the first interface and the second interface, a first sidewall between the first interface and the second interface, and a second sidewall between the first interface and the second interface;
a first groove in the surface, wherein the first groove extends between the first interface and the second interface, and is closer to the first sidewall than to the second sidewall; and
a second groove in the surface, wherein the second groove extends between the first interface and the second interface, and is closer to the second sidewall than to the first sidewall,
wherein a depth of the first groove is different from a depth of the second groove.

2. The apparatus of claim 1, wherein the depth of the first groove is less than or equal to about 90% of the depth of the second groove.

3. The apparatus of claim 1, wherein a width of the first groove is different from a width of the second groove.

4. The apparatus of claim 1, wherein an angle between the surface and a sidewall of the first groove is different from an angle between the surface and a sidewall of the second groove.

5. The apparatus of claim 1, wherein a distance between the first groove and the second groove is between about 50% and about 99% of the distance between the first sidewall and the second sidewall.

6. The apparatus of claim 1, wherein a distance between the first sidewall and the first groove is less than about 50% of a distance between the first sidewall and the second sidewall.

7. The apparatus of claim 1, wherein outside of the first groove and the second groove, the surface has a flat portion, and wherein a bottom of the first groove is substantially parallel to the flat portion of the surface.

8. The apparatus of claim 1, wherein the surface is a first surface, the body further comprises a second surface, and the apparatus further comprises a recess in the second surface of the body.

9. The apparatus of claim 1, further comprising a plurality of openings in the body, the plurality of openings extending between the first interface and the second interface.

10. An apparatus, comprising:
a body comprising a first interface and a second interface opposite the first interface;
a first alignment structure in the body, extending between the first interface and the second interface; and
a second alignment structure in the body, extending between the first interface and the second interface,
wherein the first alignment structure and the second alignment structure differ in a dimension.

11. The apparatus of claim 10, wherein the dimension is a first dimension, the first alignment structure and the second alignment structure further differ in a second dimension, and the second dimension is different from the first dimension.

12. The apparatus of claim 10, wherein the body comprises a surface between the first interface and the second interface, and wherein the first alignment structure is an opening extending from the surface into the body.

13. The apparatus of any one of claim 12, wherein the opening is a first opening, and the second alignment structure is a second opening in the body.

14. The apparatus of claim 13, wherein a portion of the first opening extends from the surface into the body along a first angle, a portion of the second opening extends from the surface into the body along a second angle, and the first angle is substantially equal to the second angle.

15. The apparatus of claim 13, wherein the second opening is surrounded by the body.

16. The apparatus of claim 15, wherein the first opening comprises a first hole, and the second opening comprises a second hole.

17. The apparatus of claim 16, wherein, in a cross-section along a plane substantially parallel to the first interface, at least a portion of the first hole has a first elliptical shape, at least a portion of the second hole has a second elliptical shape, and the second elliptical shape has a higher eccentricity than the first elliptical shape.

18. An apparatus, comprising:
a body comprising a first interface, a second interface opposite the first interface, a surface between the first interface and the second interface, a first sidewall between the first interface and the second interface, and a second sidewall between the first interface and the second interface;
a waveguide in the body, the waveguide extending between the first interface and the second interface;
a first groove in the surface, the first groove extending from the first interface towards the second interface, the first groove extending from the first interface towards the second interface, the first groove closer to the first sidewall than to the second sidewall; and
a second groove in the surface, the second groove extending from the first interface towards the second interface, the second groove extending from the first interface towards the second interface, the second groove closer to the second sidewall than to the first sidewall;
wherein a depth of the first groove is different from a depth of the second groove.

19. The apparatus of claim 18, wherein the first groove extends partway between the first interface and the second interface.

20. The apparatus of claim 18, wherein the first groove and the second groove further differ in a length or a width.
